(19) United States
(12) Patent Application Publication
(10) Pub. No.: US 2026/0311502 A1
(43) Pub. Date: Oct. 8, 2026

(54) Single Molecule Tracking Using Graph Neural Networks

(71) Applicant: Eikon Therapeutics, Inc., Millbrae, CA (US)

(72) Inventors: Alec Heckert, Cambridge, MA (US); Ruth Wendland Godbey, San Mateo, CA (US)

(21) Appl. No.: 19/581,008

(22) PCT Filed: Sep. 20, 2024
(86) PCT No.: PCT/US2024/047595

§ 371 Date: Apr. 22, 2026

Related U.S. Application Data
(60) Provisional application No. 63/584,458, filed on Sep. 21, 2023.

(51) Int. Cl. G06V 20/69; G06V 10/764; G06V 10/766; G06V 10/82; G06V 10/86

(52) U.S. Cl. CPC G06V 20/698; G06V 10/764; G06V 10/766; G06V 10/82; G06V 10/86

(57) ABSTRACT

Single molecule tracking (SMT) is performed using a graph neural network. A sequence of images visualizing movement of a plurality of molecules is received (e.g., received after being transmitted over a computer network, accessed from storage, etc.). Spots are detected within the images which correspond to a plurality of molecules. A graph neural network generates classifications corresponding to one or more molecule analysis tasks based on the detected spots. Data characterizing the generated classifications can be provided to a consuming application or process for various downstream molecular analysis tasks.

### RELATED APPLICATION

This application claims priority to U.S. Pat. App. Ser. No. 63/584,458 filed on Sep. 23, 2023, the contents of which are hereby fully incorporated by reference.

### TECHNICAL FIELD

The subject matter described herein relates to techniques for tracking the trajectories of molecules captured in images using machine learning, and in particular, graph neural networks.

### BACKGROUND

Live cell single molecule tracking (SMT) is a versatile tool to measure the behavior and interactions of proteins in their native cellular environment. Although many labeling modalities and microscopies capable of SMT exist, all aim to recover spatiotemporal coordinates of individual molecules such as proteins in living cells. Typically these coordinates are linked through time to yield trajectories. In turn, a myriad of analysis approaches may be used to derive physical measurements of interest from trajectories (FIG. 1A).

A fundamental challenge in SMT is how to infer meaningful biological information from these spatiotemporal coordinates when little is known about the protein target in advance. The range of possible measurements that can be derived from the same SMT data is large and includes diffusion and transport kinetics, rates of state transition (such as adsorption/desorption from scaffolds), subcellular localization, and fine-scale spatial organization and clustering (FIG. 1B). Moreover, the same effect may be measured in different ways subject to distinct biases and tradeoffs.

### SUMMARY

In a first aspect, a sequence of images visualizing movement of a plurality of molecules is received (e.g., received after being transmitted over a computer network, accessed from storage, etc.). Spots are detected within the images which correspond to a plurality of molecules. A graph neural network is used to generate classifications corresponding to one or more molecule analysis tasks based on the detected spots. Data characterizing the generated classifications can be provided to a consuming application or process.

The graph neural network can take various forms including a graph attention network, a message passing network, a graph convolution networks, a scalable injection graph neural network, and/or a network propagation model each comprising a plurality of layers.

The detecting can generate coordinates for each spot which are used to generate a vertex z representing one of the molecules. The graph attention network can compute, for each layer, attention coefficients α for each vertex z over neighbors corresponding to such vertex z and generates a new representation of such vertex z using graph convolutions weighted by the corresponding attention coefficients α. The attention coefficients α can vary over time.

The molecule analysis tasks can take varying forms. As one example, one of the molecule analysis tasks can be a graph classification. The graph classification can indicate whether the molecules in the sequence of images have been treated with one or more classes of compounds. As another example, one of the molecule analysis tasks can be a graph regression. In such an example, the graph neural network can output a single scalar number corresponding to an entire graph. This single scalar number can predict a mean diffusion coefficient over all spots in the sequence of images and/or a concentration of a compound applied to the molecules. Another example of a molecule analysis task is a vertex classification. The vertex classification can specify a categorical attribute for each of the detected spots. The categorical attribute can specify whether the detected spots correspond to a molecule of interest, the detected spots as comprising dye or being junk. The categorical attribute can additionally or alternatively specify a type of motion for the molecule corresponding to an associated spot. One of the molecule analysis tasks can be an edge classification. The edge classification can specify or otherwise characterize a likely trajectory of a molecule within the sequence of images.

The sequence of images can comprise a sequence of microscopy images visualizing fluorescently-labeled cellular components in live cells. Further, the sequence of microscopy images can visualize the fluorescently-labeled cellular components while the live cells are being subjected to compounds or varying environmental conditions.

In other variations, the current subject matter can be utilized to analyze a sequence of microscopy images of a cell-free sample.

In some variations, an ensemble of machine learning models can be utilized. In an interrelated aspect, a sequence of images visualizing movement of a plurality of molecules is received (e.g., received after being transmitted over a computer network, accessed from storage, etc.). Spots within the images are detected which correspond to the plurality of molecules. The ensemble of machine learning models are used to analyze characteristics of the molecules within the sequence of images based on the detected spots. The ensemble of machine learning models can include a graph neural network and a probabilistic tracking algorithm. Data characterizing the analysis is provided to a consuming application or process. In some variations, as part of the analyzing, the probabilistic tracking algorithm can consume or otherwise utilize an output of the graph neural network.

In a further interrelated aspect, a sequence of images visualizing movement of a plurality of molecules is received (e.g., received after being transmitted over a computer network, accessed from storage, etc.). Spots within the images are detected which correspond to the plurality of molecules. Using a graph neural network and based on the detecting, molecules of interest are identified within the sequence of images. These identified molecules can then be analyzed (using for example, various computer vision or other machine learning algorithms, etc.) and data characterizing the analysis is provided to a consuming application or process. This consuming application or process can be yet another machine learning model or models which can characterize the molecules.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a schematic of an SMT experiment;

FIG. 1B illustrates example measurements of interest in SMT;

FIG. 1C is a schematic of an SMT analysis workflow;

FIG. 2 illustrates tracking with graph attention networks (GATs) as a candidate GNN framework;

FIG. 3A illustrates a problem associated with distinguishing between true dye molecules and non-dye junk in SMT movies;

FIG. 3B is a schematic showing a weakly-supervised training approach;

FIG. 3C illustrates an evaluation procedure;

FIGS. 3D-F illustrate comparisons to other tracking approaches;

FIG. 4A is a schematic illustrating the use of GATs to quantify compound effects on estrogen receptor (ER)-HaloTag in U2OS cells;

FIG. 4B is a visualization of model outputs on a DMSO- or estradiol-treated sample;

FIG. 4C illustrates a fraction of particles exhibiting “estradiol-like” motion as a function of compound concentration for various steroids;

FIG. 4D illustrates the ability of GATs to resolve estradiol and DMSO treatment, measured with strictly-standardized mean difference (SSMD);

FIG. 5A illustrates a GAT training procedure to identify compound treatments in cellular SMT data;

FIG. 5B visualizes model outputs on insets of three example movies treated with DMSO, a second compound, or No Dye;

FIG. 5C visualizes a comparison of the model's outputs with a traditional tracking pipeline;

FIG. 6A includes frames from simulated SMT movies with fractional Brownian motion;

FIG. 6B is a schematic of a regression task in which, given a set of spots in an SMT movie, a graph is constructed and the GNNs are used to predict the Hurst parameter for each spot;

FIG. 6C illustrates randomly sampled trajectories from the test set, organized by true Hurst parameter (x-axis) and colored by predicted Hurst parameter;

FIG. 6D illustrates the accuracy of the regression model on a test set;

FIG. 6E illustrates bias of a model at the individual vertex level;

FIG. 7 is a schematic of an example computing architecture for implementing aspects of the current subject matter;

FIG. 8 is a schematic of an example computing device for implementing aspects of the current subject matter;

FIG. 9 illustrates an example workflow for executing one or more molecule analysis tasks; and

FIG. 10 is a process flow diagram illustrating the execution of one or more molecule analysis tasks using one or more graph neural networks.

### DETAILED DESCRIPTION

The current subject matter is directed to the performance of various molecular analysis tasks using a graph neural network (GNN)-based framework which learns the appropriate quantification of data (e.g., SMT data, etc.) from a labeled set of perturbations de novo. The current approaches capture workhorse analyses of SMT data—such as tracking and diffusion coefficient estimation—as special cases. The current techniques provide many technical advantages particularly with addressing challenging problems such as anomalous diffusion estimation without explicit linking.

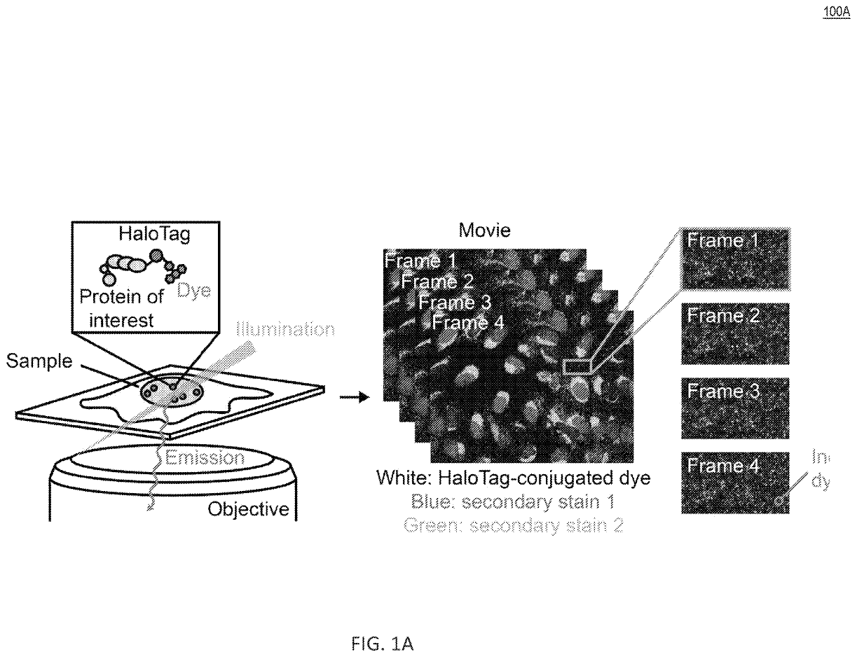

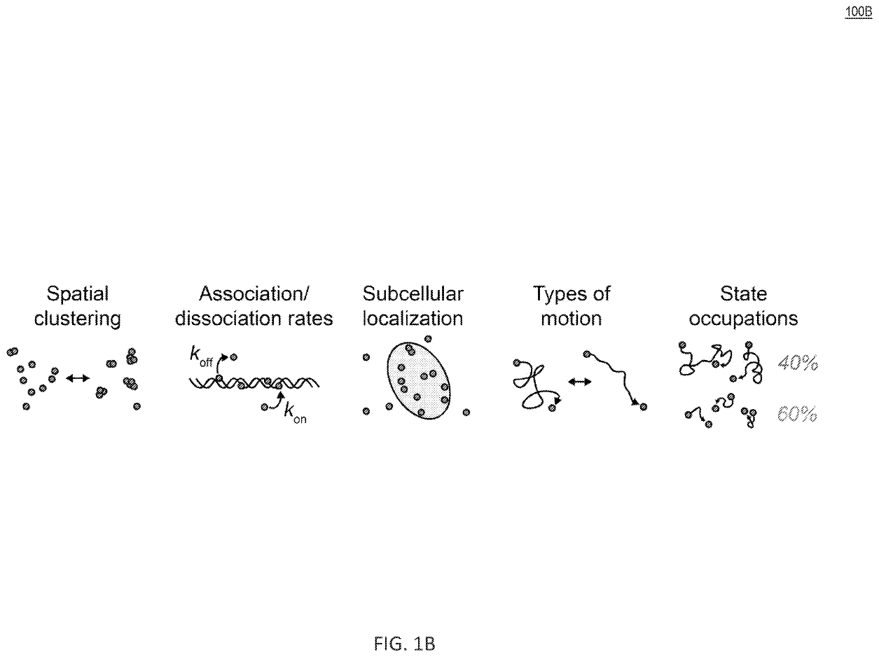

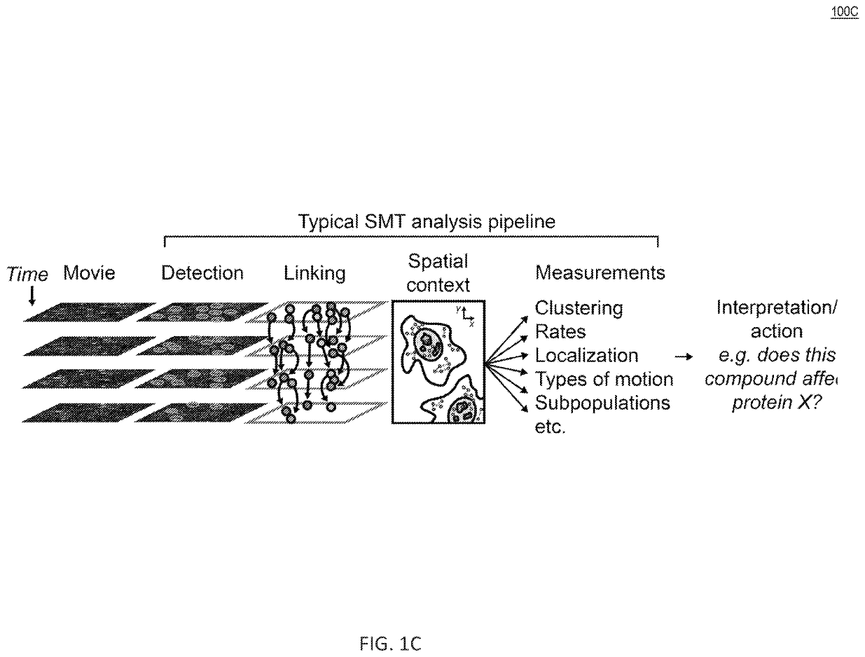

FIGS. 1A-1C are diagrams 100A-100C illustrating an example single molecule tracking (SMT) workflow and molecular analysis tasks. FIG. 1A is a schematic of an SMT experiment in which a sample, such as live cells bearing a protein of interest labeled with a fluorescent dye, are illuminated with an excitation sheet. Emission light is collected by the same objective and integrated over a short timescale, typically less than 2 ms. Combined with secondary stains, this yields a timeseries in which the positions of individual dye molecules are encoded as small, bright “spots” on a black background. FIG. 1B illustrates example measurements of interest in SMT. Each dot represents a dye molecule. As shown in FIG. 1B, some readouts (clustering or subcellular localization) are purely spatial, while others (rate constants, types of motion, state occupations) are dynamical. FIG. 1C illustrates a typical SMT analysis workflow. Positions of individual dye molecules are identified in a raw timeseries using a computer vision step, linked through time into trajectories, and subjected to downstream analyses as appropriate for the task. In a drug discovery context, the actionable readout is typically not a single measurement (e.g. a diffusion coefficient or dissociation rate constant) but an overall indication of whether a treatment changes anything about a target's dynamics. The current subject matter considers combining linking, spatial context, and downstream analyses into a single trainable model based on GNNs.

To illustrate how GNNs generalize SMT analysis, a formalism for tracking algorithms is described. This formalism is then used to define a GNN framework for SMT.

Let V be the sequence of detections recovered from an SMT movie. Each detection v∈V is equipped with a vector of attributes xᵥ∈ [symbol] ⁿ that may include its position (x, y, z, t coordinates) as well as any intensity or shape-related attributes (width, root mean squared deviation with respect to a fit, etc.). X∈ [symbol] ^{|v|×n} is used to denote the matrix of attributes for all detections.

A graph G=(V, E) is constructed such that each edge i→j∈E represents a potential identity relation between two detections: the hypothesis that two detections originate from the same dye molecule. To prevent the number of edges from becoming astronomically large, there can be requirements that edges satisfy some physical constraints. For example, edges connecting two detections too far apart in space or time can be excluded. The goal of a tracking algorithm is to recover a subset of the remaining edges S⊆E such that no two edges in the subset begin or end at the same detection. Because many viable subsets S may exist, the aim is to find the particular S* that maximizes some objective function ƒ. Finally, connected components (trajectories) in this subgraph are used to derive physical measurements of interest θ with some estimator θ*=g(V, X, S*). The overall inference scheme can be stated

$${θ}^{*} = g [ 𝒱 , 𝒳 , {arg max}_{𝒮} f ( 𝒮 \vert 𝒱 , 𝒳 ) ]$$

Because S is discrete, the function ƒ is non-differentiable with respect to S. As a result, workhorse tracking algorithms rely on expensive combinatorial optimization schemes to take argmax ƒ.

This poses a challenge: if the goal is to identify an optimal estimator g of our desired readout θ, it must be conditioned on a particular tracking algorithm (that is, one solution to argmax ƒ). In SMT, it is well known that different measurements θ require different tracking algorithms. For instance, estimating diffusion coefficients requires a different kind of tracking than estimating residence times. Moreover, tracking may not be the best approach at all for certain classes of problems-such as measuring spatial clustering.

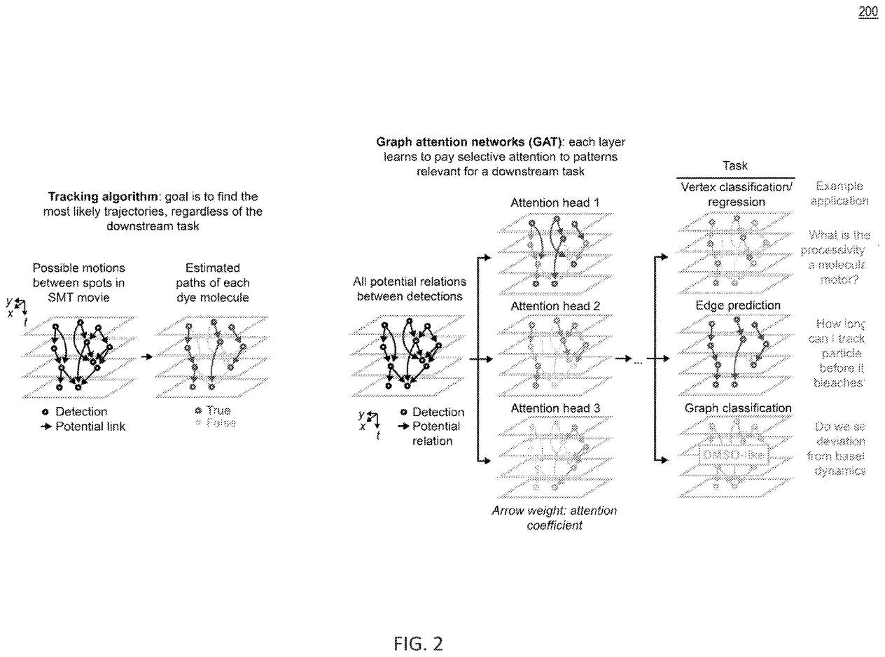

To address this problem, the current subject matter utilizes a more general class of estimators that are fully differentiable with respect to their inputs. GNNs are one such class, providing a class of functions θ=h(V, X, E) fully differentiable with respect to X. Classes of GNNs such as graph attention networks (GATs), by learning a weighting scheme for the edges E, in effect can learn the notion of tracking (taking a subset S⊆E) if relevant for the problem. Moreover, GNNs are suited to three tasks of interest in SMT (FIG. 2), corresponding to three flavors of the readout θ:
One output per vertex/detection (for example, estimating the diffusion coefficient or type of motion for every detection in a movie).
One output per edge (for example, identifying the correct set of trajectories).
One output for the entire graph (for example, determining whether a movie exhibits significantly different dynamical properties than DMSO).

The current subject matter, for illustration purposes, focuses on the first task (one output per vertex). Several GNN layers appropriate for this task, building on the GCN, SIGN, and GAT architectures are described in detailed below. These GNN layers were incorporated into a single C++ package facilitating evaluation of GNNs on large SMT data (millions of vertices).

FIG. 2 is a diagram 200 which illustrates tracking with graph attention networks (GATs) as a candidate GNN framework. A tracking algorithm begins with a graph of all detections and potential links in one SMT movie and attempts to find the subset of edges corresponding to true motions of individual dye molecules. Each layer of a GAT begins in the same place—with a graph of relations between spots. However, rather than attempting to find the “correct” connections between particles, a GAT layer is instead divided into multiple attention heads that learn to recognize distinct patterns in this graph, represented as attention coefficients (edge weights). These patterns are used to produce the input representation to the next GAT layer. Because the attention weights in any attention head are normalized over all outgoing and incoming edges to each vertex, they relate closely to the link weights estimated by a probabilistic tracking algo.

### Classification of Dye/Non-Dye Particles.

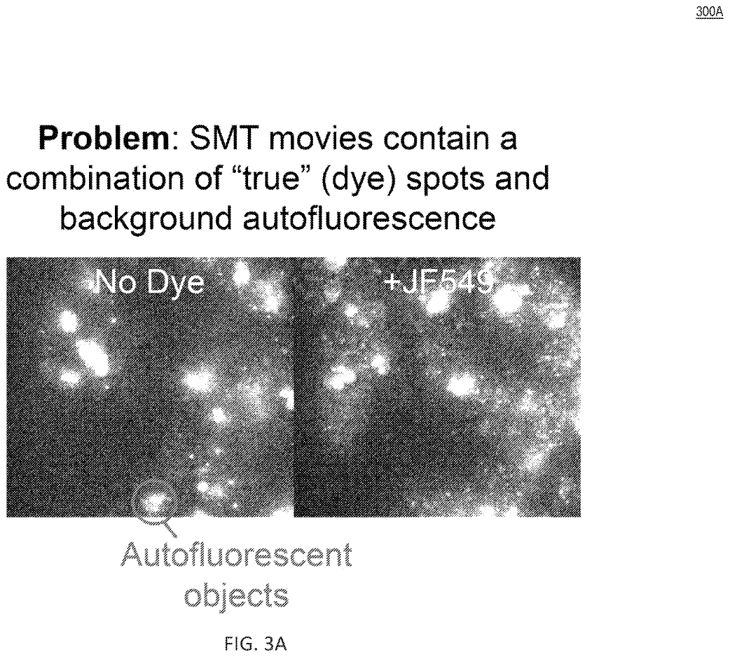

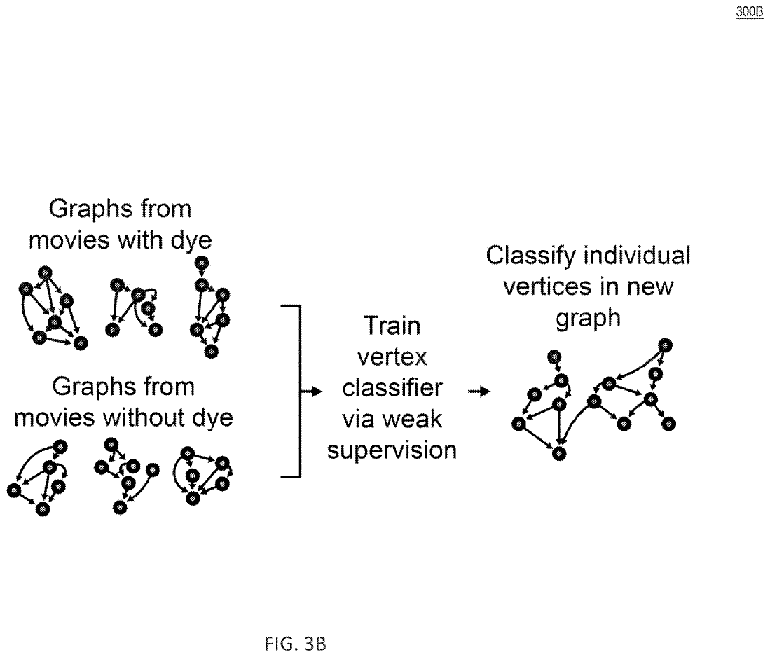

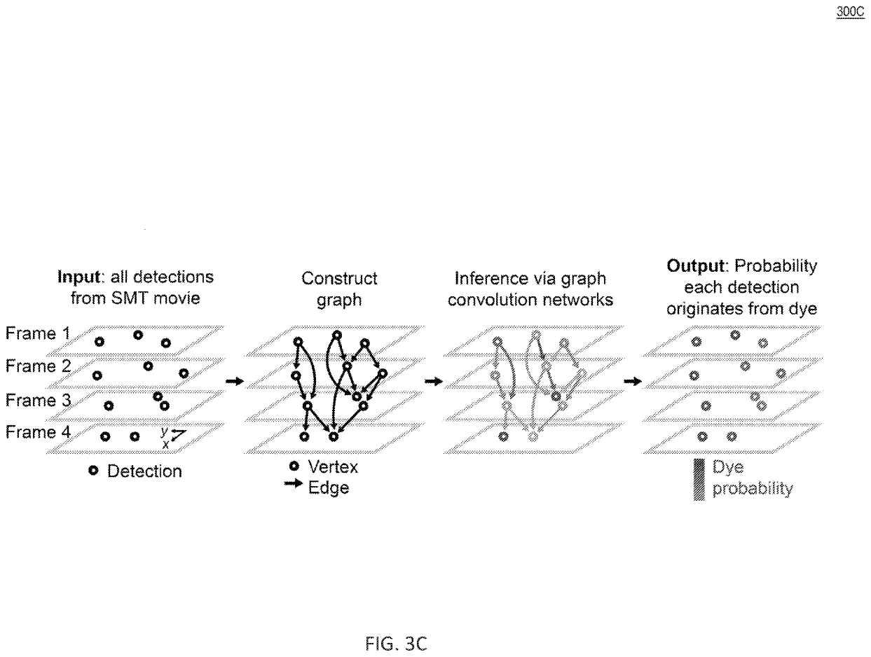

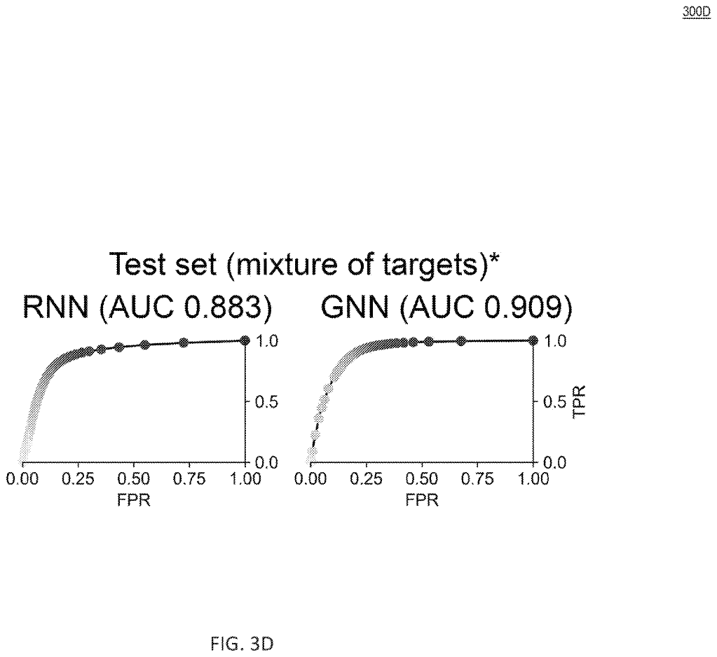

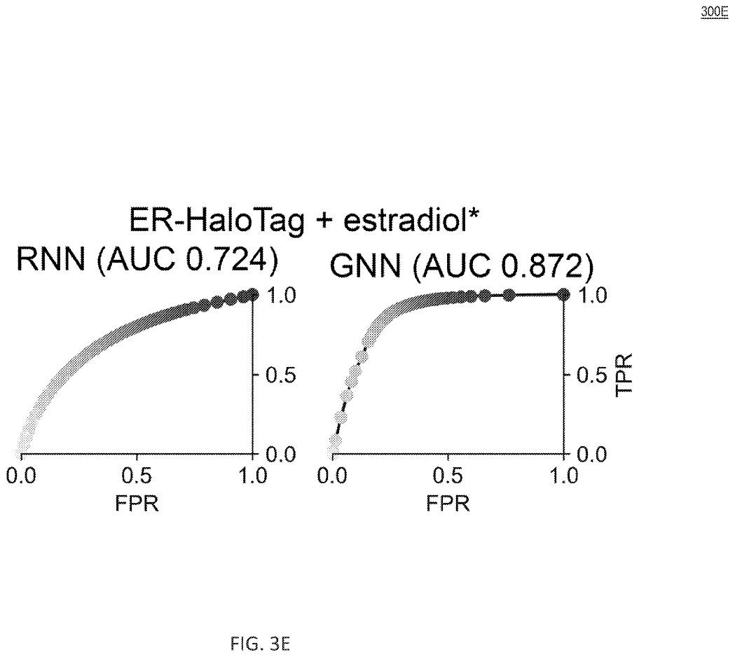

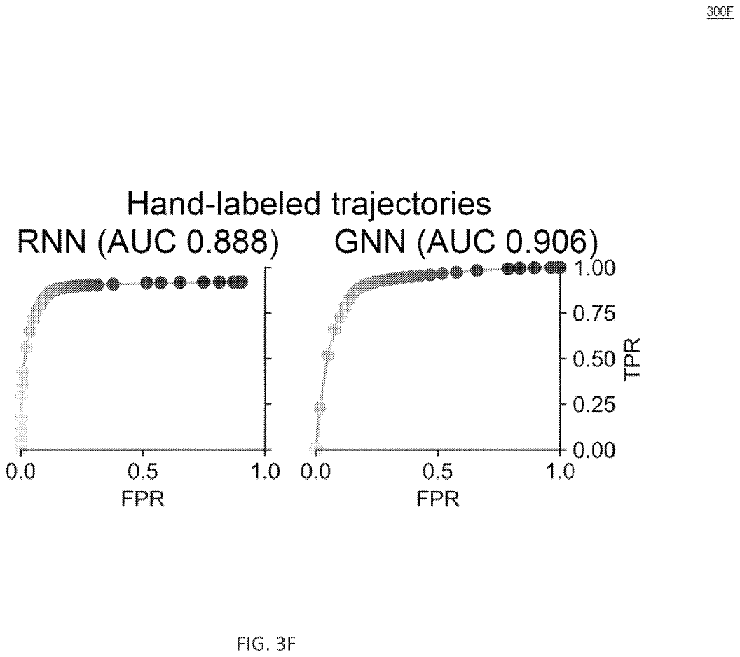

FIGS. 3A-3F are diagrams 300A-300F illustrating the use of GNNs to distinguish between true dye molecules and non-dye “junk” in SMT movies. FIG. 3A illustrates a problem in which SMT movies work at low labeling levels where true detections from dyes compete with false detections from autofluorescent background. FIG. 3B illustrates a weakly-supervised training approach. The model is shown graphs derived from movies with or without dye labeling. The objective is to predict the probability that any given detection/vertex originates from a movie with labeling. This enables the model to distinguish between patterns in the same graph that are associated with labeled or unlabeled movies. FIG. 3C illustrates an evaluation procedure in which the input is the set of all detections from one SMT movie. Edges are constructed between these vertices according to the rules provided below. This graph is fed into a convolutional GNN, and the output is one scalar per vertex—the probability that the vertex originates from a labeled SMT movie. FIGS. 3D-3F illustrates comparisons of the GNN with a previous, tracking-based approach (recurrent neural networks/RNNs). The RNN approach predicts the probability that each trajectory in an SMT movie originates from a dye molecule, and is trained on hand-labeled trajectories. FIG. 3D shows the receiver operating characteristic (ROC) on the GNN's test set comprising 1464 SMT movies from a variety of cell lines and targets which illustrates false positive rate (FPR) relative to true positive rate (TPR). FIG. 3E shows ROC on only estradiol-treated ER-HaloTag movies in U2OS cells, and FIG. 3F shows ROC on the RNN's training set comprising 10000 hand-labeled trajectories. ROCs are evaluated at the trajectory level for the RNN and at the vertex level for the GNN (the respective output domains for these two models). Note that ER-HaloTag+estradiol is nearly immobile, making it challenging to distinguish from non-dye background.

Cells contain autofluorescent compounds—such as NADH, flavins, lipofuscins, and porphyrins—that introduce contaminating background signal in SMT experiments. Because these autofluorescent metabolites are often localized in spot-like patterns, they can be challenging to distinguish from bona fide dye molecules and are often recovered by detection algorithms (FIG. 3A). So an important task for automated SMT is to determine whether each detection in an SMT movie originates from a true dye molecule.

A challenge is the scarcity of high-quality labeled training data. Because labeling every detection in a single SMT movie is usually impossible (the number of detections can be in excess of 10⁶), existing labels are highly biased toward the most obvious cases. To address this challenge, a weakly-supervised training scheme was utilized (FIG. 3B). In this approach, a model is shown graphs derived from cellular SMT movies with or without labeling (in this case, the labeled condition uses JF549, a rhodamine dye). All spots originating from unlabeled movies are non-dye, whereas spots originating from labeled movies may or may not be dye. The model is rewarded for identifying patterns that are preferentially associated with either the labeled or unlabeled condition.

The model takes the set of spots from one SMT as input and predicts one scalar per vertex (FIG. 3C). The model uses the SIGN method (as described in further detail below) to enrich the features associated with each vertex, followed by two chains of graph convolutional layers (GCNs) running forward and backward in time. The outputs of both convolution chains are then concatenated and fed into a small vertex-level multilayer perceptron (MLP) that predicts the probability that each spot is a dye molecule. The model architecture is detailed in further detail below.

The GNN approach was compared against a previous, recurrent neural network (RNN)-based approach (FIG. 3D-F). First, the two approaches were compared on a test set comprised of 1464 movies (732 with dye, 732 without dye) from several cell lines and targets. The goal for the GNN was to determine whether each spot originated from a movie with dye, whereas the goal for the RNN was to determine whether each trajectory of length 4 spots or greater originated from a movie with dye. Because there is more information in a trajectory than in a spot, the task for the RNN is generally easier; moreover the RNN operates on trajectories produced by a tracking algorithm, whereas the GNN operates on the raw detections. Despite this, the GNN outperformed the RNN in terms of area under the receiver operating characteristic (ROC) (FIG. 3D).

Because autofluorescent non-dye objects tend to be immobile, they are more challenging to distinguish when the dye-labeled protein target is also immobile. Both RNN and GNN approaches were evaluated on a test set comprised of JF549-labeled or unlabeled ER-HaloTag in U2OS cells treated with estradiol (FIG. 3E). Under these conditions, ER-HaloTag is mostly immobile. It was observed that there was a substantial boost in performance of the GNN over the RNN approaches. Whereas the RNN's ROC AUC degrades to 0.724, the GNN's performance is only slightly decreased (changing from 0.909 to 0.872, reflecting a slight bias to classify immobile dye as non-dye).

The RNN and GNN approaches were also compared on a dataset of 10000 hand-labeled trajectories, mostly from U2OS cells (FIG. 3F). This dataset was the training dataset for the RNN approach. As before, the ROC for the RNN was evaluated at the trajectory level (only on trajectories with 4 spots or greater), while the ROC for the GNN was evaluated at the spot level (on all spots). Interestingly, despite these handicaps, the GNN outperforms the RNN on this dataset.

The experiments described herein confirm that the GNN approach represents significant gains in performance over the RNN model for dye/non-dye classification. Apart from the improvements in accuracy, a 6-7× speed improvement of the GNN over the RNN was obtained. The RNN required an average of 1.589 CPU-seconds per FOV, while the GNN required on average 0.208 CPU-seconds per FOV (including graph construction).

### Distinguishing Compound Effects on Motion.

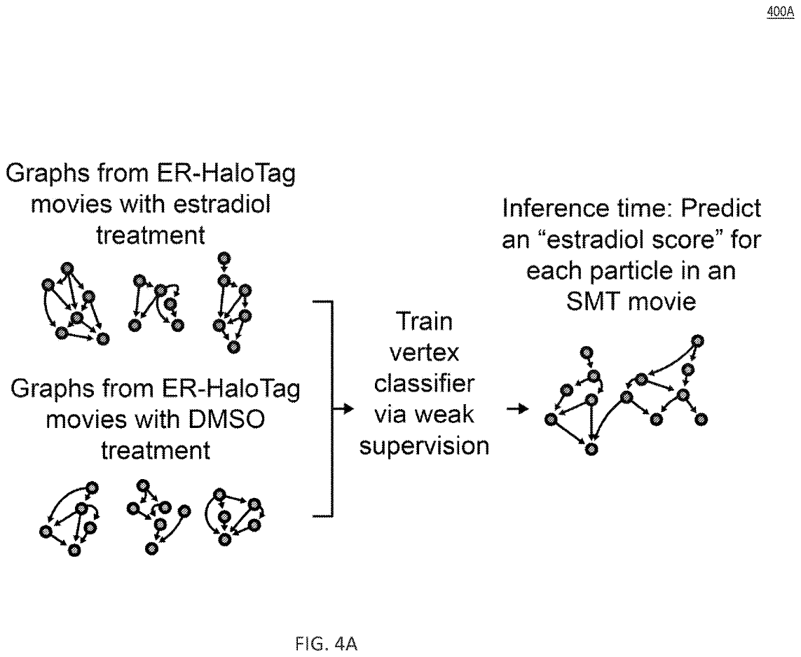

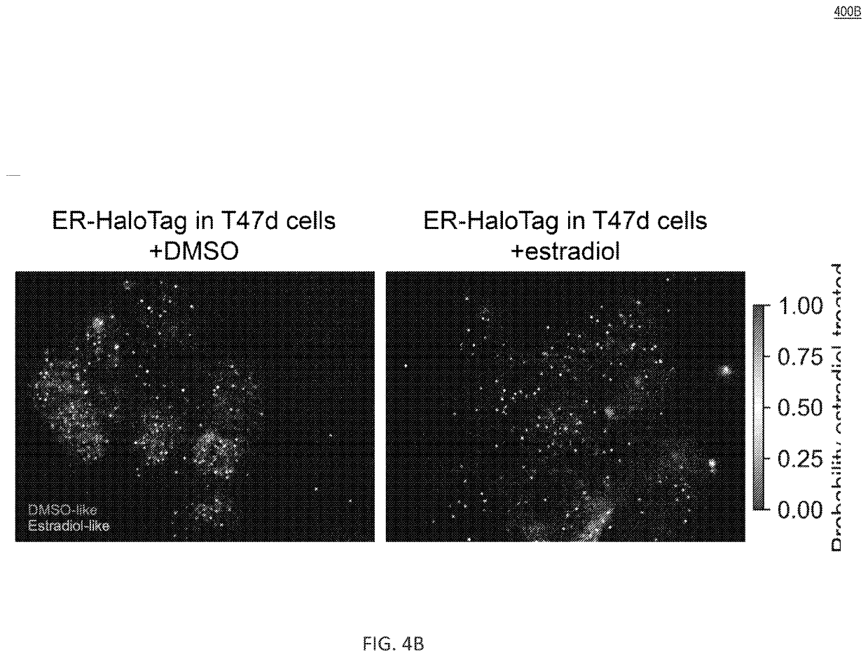

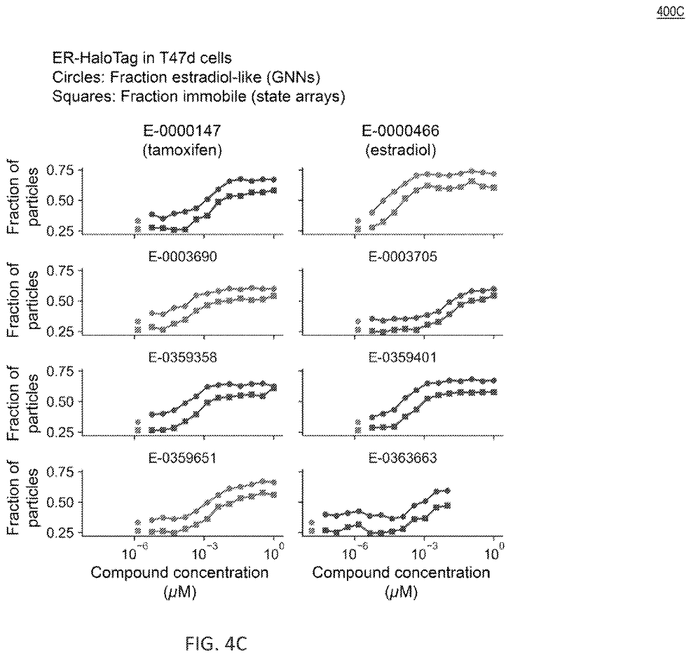

FIGS. 4A-4D are diagrams 400A-400D illustrating the use of GATs to quantify compound effects on estrogen receptor (ER)-HaloTag in U2OS cells. FIG. 4A is a schematic of the problem to classify each detection in an ER-HaloTag SMT movie as DMSO-treated or estradiol-treated. However, ground truth annotations for estradiol treatment at the single particle level do not exist. Instead, a weakly-supervised scheme was pursued in which the model is shown movies from DMSO- or estradiol-treated cells, and learns to recognize patterns associated with each movie. A mixture of these patterns exist under both DMSO and estradiol treatment, but may be preferentially associated with one or the other. FIG. 4B is a visualization of model outputs on a DMSO- or estradiol-treated sample. Particles are colored according to model predictions, with red and blue indicating “DMSO-like” and “estradiol-like” modes of motion, respectively. FIG. 4C illustrates a fraction of particles exhibiting “estradiol-like” motion as a function of compound concentration for various steroids. Squares indicate the fraction of immobile particles as estimated by state arrays, a tracking-based readout, and circles are the fraction of estradiol-like particles as predicted by GATs. FIG. 4D illustrates the ability of GATs vs. tracking to resolve estradiol and DMSO treatment, measured with strictly-standardized mean difference (SSMD). Q3JL is the third quartile of the jump length distribution and DCM is the maximum likelihood diffusion coefficient, both tracking-based readouts. The fraction of estradiol-like particles is the fraction of detections with estradiol score above 0.5, as emitted by the GAT.

Because SMT can measure perturbations to proteins in their native cellular environment, the method is of potential interest for drug discovery efforts. Typical drug discovery approaches involve one or more screens of a protein target against a library of thousands to millions of compounds. Compounds producing assay outputs significantly different than a negative control (usually DMSO) can also be utilized. For the assay output, a real-valued scalar reflects the degree to which the target is perturbed by the respective compound.

As with any image-based assay, the challenge is a lack of knowledge about the kind of effects expected to be observed from hit compounds. While a typical protein target may have tool compounds (positive controls known to affect its function) available, usually the consequence of these changes for the dynamical and spatial outputs of SMT are unknown.

As described herein, a GNN was defined that automatically identifies appropriate readouts for a protein target in SMT, given example movies of the target treated with controls. Using two exemplary protein targets, a model was defined which is capable of learning how to measure perturbations to each of the corresponding proteins from the raw detections in an SMT movie. For the first exemplary target, the estrogen receptor (ER), the task was to distinguish the effects of two compound treatments on ER-HaloTag: DMSO (a negative control) and estradiol (an archetypal agonist of ER). A weakly supervised approach was used: the model was shown graphs from SMT movies of ER treated with DMSO or estradiol. The task was to assign each detection an “estradiol score”: the probability the detection originates from a sample under estradiol treatment (FIG. 4A). Effectively, this scheme encouraged the network to learn local patterns in SMT movies associated with DMSO or estradiol treatment.

Visually inspecting the model's outputs (FIG. 4B), it is noted that the model learned to associate estradiol treatment with immobile particles. Using the fraction of “estradiol-like” particles as a readout, the model's predictions were compared against an orthogonal, tracking-based readout (fraction immobile particles from state arrays). Despite only being trained on a single concentration of estradiol treatment, the model learned to distinguish between different concentrations of estradiol and also identified the effect of a variety of other steroids (FIG. 4C). Interestingly, changes in the fraction of “estradiol-like” particles recovered by GATs were quantitatively similar to changes in the fraction of immobile particles recovered by state arrays. Finally, the statistical effect size of estradiol treatment was compared as quantified by GATs or by traditional tracking-based readouts (third quartile of the jump length distribution (Q3JL) or max likelihood diffusion coefficient (DCM)) (FIG. 4D). Despite being trained only a single plate of SMT data, the GAT model generalized to this setting and produced effect sizes competitive with tracking.

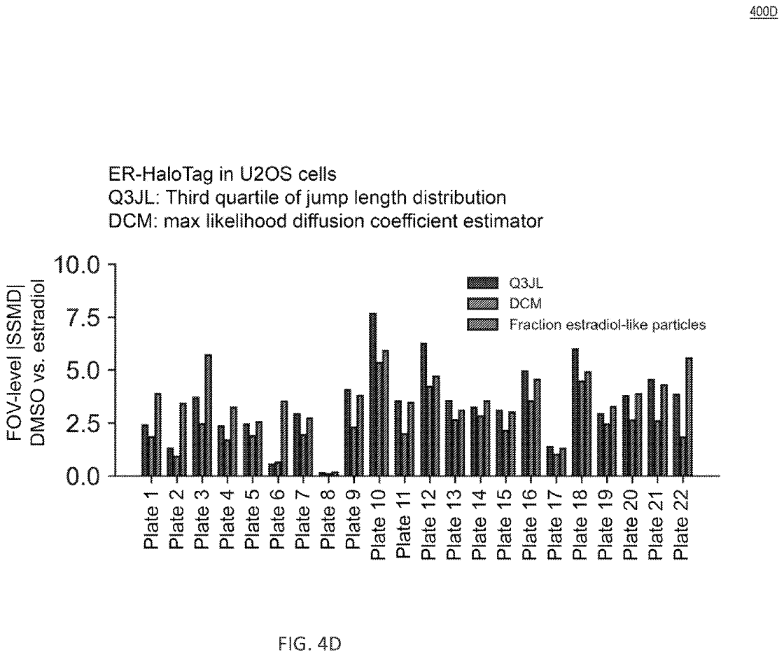

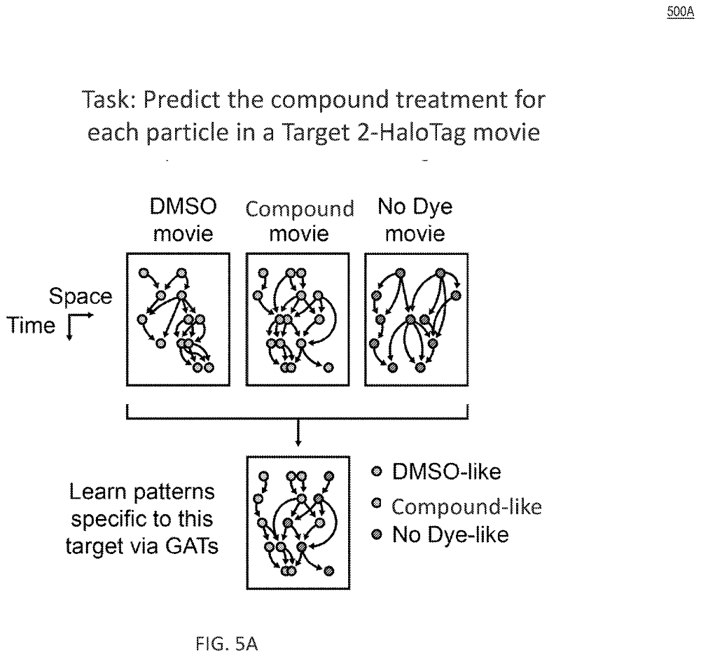

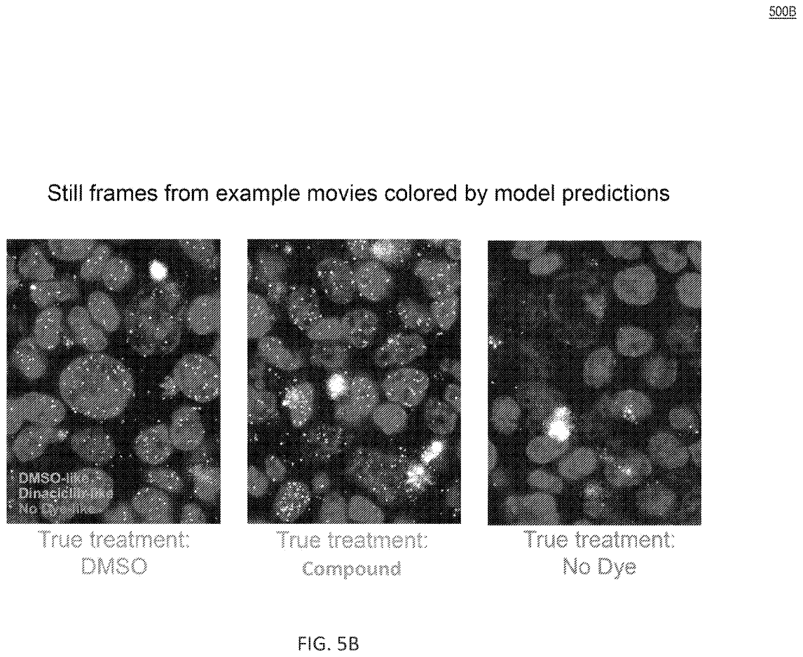

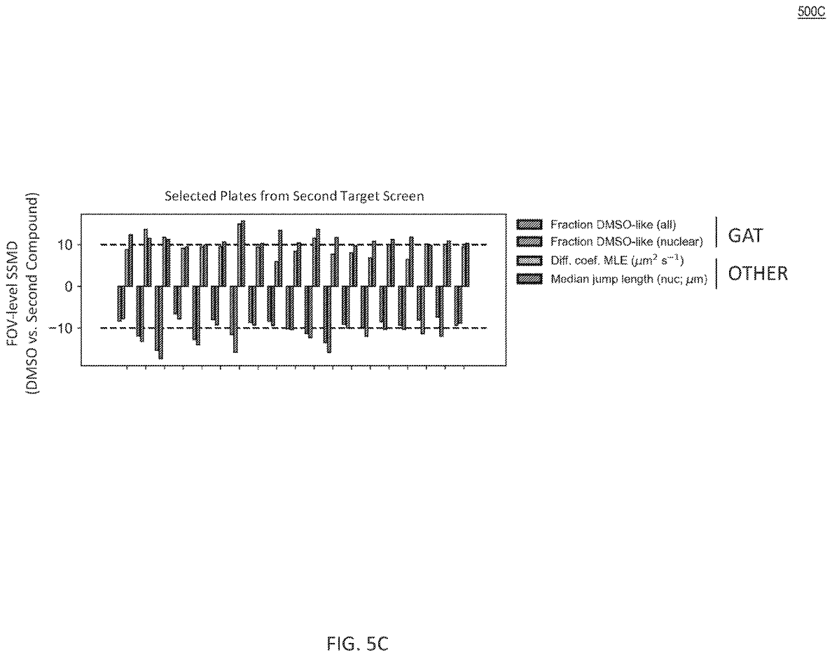

FIGS. 5A-5C are diagrams 500A-500C illustrates graph attention networks (GATs) trained to identify compound treatments in cellular SMT data, using Target 2-HaloTag in HCT116 cells as a test case. FIG. 5A is a schematic of a training procedure in which the model is shown graphs derived from SMT movies under one of three distinct treatments: DMSO (a negative control), a second compound (a positive control affecting the second target's dynamics), or No Dye (reflecting non-target background). The task is to predict the parent movie's label for each vertex. FIG. 5B are visualizations of the model outputs on insets of three example movies treated with DMSO, a second compound, or No Dye. The pixels have been colored to reflect the output probabilities of the model for each vertex and category; although the model produces outputs for every vertex in every frame, only an inset of one frame is shown here. “DMSO-like”, “compound-like”, and “No Dye-like” are the probabilities that a vertex originates from a DMSO-treated, compound-treated, or No Dye-treated sample, respectively. FIG. 5C illustrates a comparison of the model's outputs with a traditional tracking pipeline, using an actual SMT-based primary screen as a test case. FOV-level SSMD is the strictly-standardized mean difference (SSMD) computed between all movies from the DMSO and second compound conditions on the corresponding 384-well plate. “Fraction DMSO-like” is the fraction of vertices with DMSO probability greater than 0.5 in the corresponding movie.

For the second exemplary target (Target 2), the task was to distinguish three distinct treatments: DMSO (negative control), a second compound (a positive control), and unlabeled (“No Dye”). The goal of this task was to distinguish these treatments at the spot level using a weakly-supervised approach similar to the dye classifier (FIG. 5A). In this case, the fraction of “DMSO-like” spots (spots with DMSO probability greater than 0.5) was used as the readout for the movie.

The GNNs utilized herein can be based on graph attention networks (GAT). Taking as input the set of all spots from one SMT movie, the model first constructs a graph involving connections between spatiotemporally local spots. With a multi-category model, a pair of vertex- and edge-level prediffusion layers are used to enrich the inputs associated with each vertex and edge. Several GAT layers are used that compute attention forward and backward in time. Finally, a vertex-level MLP predicts the probability that each vertex originates from each of the three categories of movies in the training set (DMSO, a second compound, No Dye). These outputs can then be analyzed at the spot-level or aggregated to yield a single number for each movie or cell instance. Further details regarding an example GNN are provided below.

Visually inspecting the model outputs on a small number of example movies, it was noted that whereas the model assigned the No Dye label to essentially all spots in true No Dye movies, the model assigned a mixture of all three labels to detections from the DMSO or compound treatments (FIG. 5B). Generally, the No Dye label was used for large autofluorescent “junk”, while the DMSO and compound labels were assigned to two distinct modes of motion whose relative occupations appear to change under second compound treatment.

The goal of drug discovery screens is to identify compounds that affect a protein target. This requires boiling all of the information from one SMT movie into a single number that can be compared against a negative control to call “hits”. To do this, the fraction of spots predicted to be “DMSO-like” were computed; this fraction is expected to decrease under compound treatment. This metric's performance can be used to distinguish DMSO vs. compound treatment against a typical tracking approach using the strictly-standardized mean difference (SSMD), a measure of effect size appropriate for high-throughput screening assays. The SSMD measures the number of standard deviations that separate the means of the two populations (DMSO and second compound treatment); its sign reflects the direction of the change. As a representative of a “typical” tracking output, the maximum likelihood estimator for the mean diffusion coefficient or the median jump length can be used (FIG. 5C). The GAT achieved similar SSMDs as the tracking pipeline on all of the test plates, demonstrating that the GAT approach is likely as viable for detecting compound effects as a more traditional tracking approach.

Detecting Deviations from Brownian Motion.

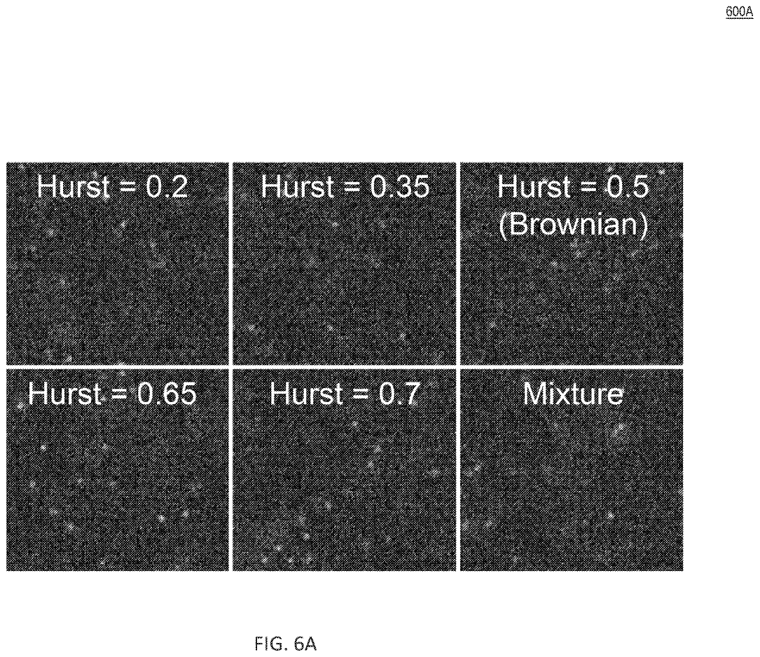

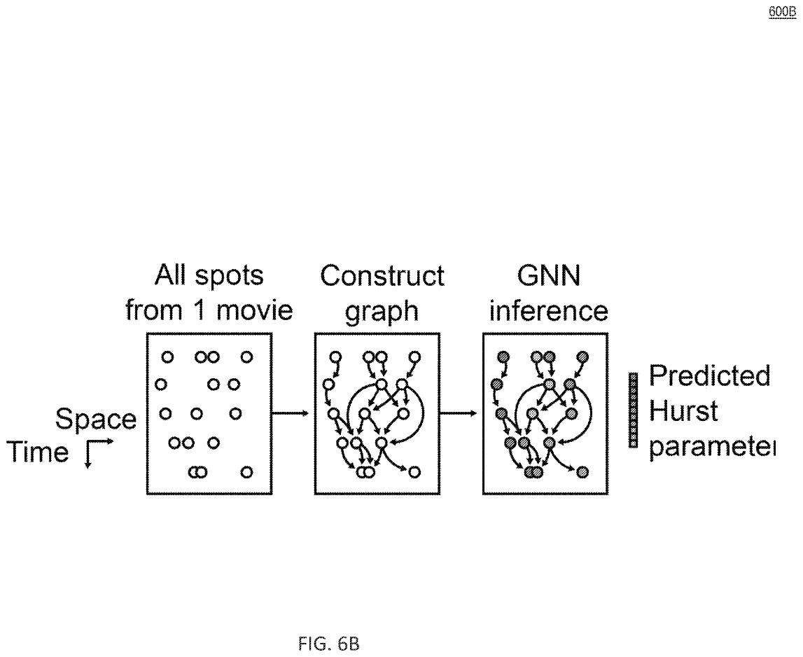

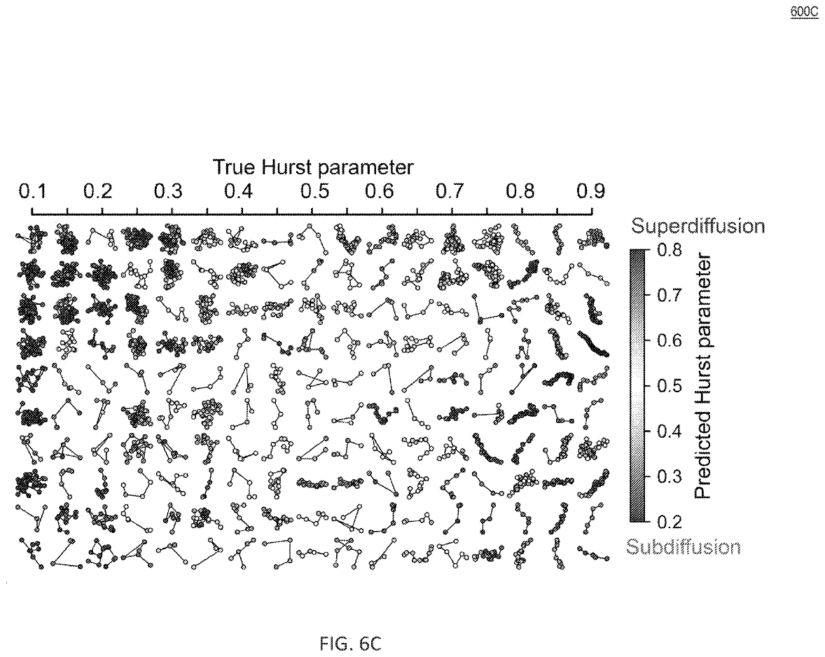

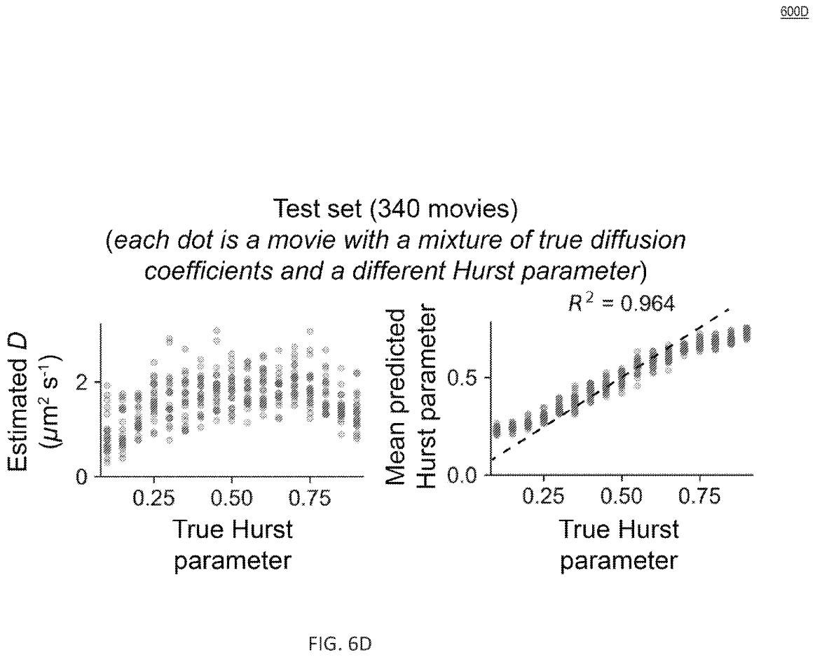

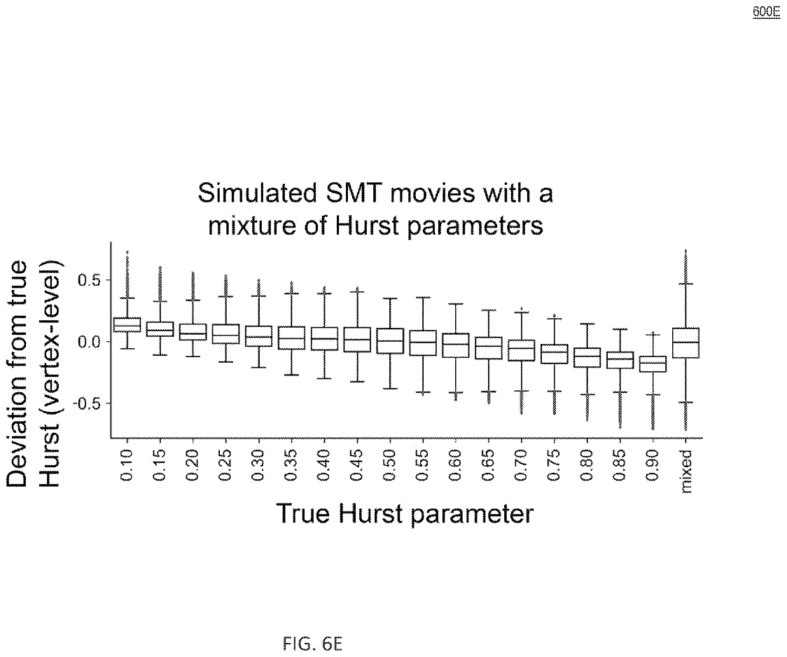

FIGS. 6A-6E are diagrams 600A-600E illustrating the use of GATs to predict deviations from anomalous diffusion, using simulated fractional Brownian motion (FBM) as a test case. FBM is governed by two dynamical parameters: the scaling coefficient and the Hurst parameter; the latter governs the type of motion and is the prediction target here. FIG. 6A visualizes example frames from simulated SMT movies with FBMs. The simulations incorporate effects such as defocus, motion blur, shot noise, and camera noise. FIG. 6B is a schematic of the regression task in which, given a set of spots in an SMT movie, a graph is constructed so that GNNs can be used to predict the Hurst parameter for each spot. FIG. 6C illustrates randomly sampled trajectories from the test set, organized by true Hurst parameter (x-axis) and colored by predicted Hurst parameter. Note that the GNN actually is blind to which vertices belong to which trajectories; the output is effectively independent of tracking. Also note that each trajectory has been rescaled to the same size for visibility; the simulated particles themselves have scaling coefficients varying by 2-3 orders of magnitude. FIG. 6D illustrates the accuracy of the regression model on the test set. “Estimated D” is the maximum likelihood diffusion coefficient, which cannot distinguish these conditions. The dotted line is a hypothetical perfect regression model. FIG. 6E illustrates the bias of the model at the individual vertex level. The y-axis is the difference between the predicted and true Hurst parameter for individual spots. “Mixed” refers to movies with a mixture of all of the Hurst parameters (0.1 through 0.9).

As an additional task, GATs were used for a vertex-level regression task in SMT: predicting deviations from Brownian motion. Proteins in cellular environments exhibit various kinds of deviation from Brownian motion including directional/superdiffusive motion (for instance, molecular motors) and subdiffusive motion (for instance, proteins in confined environments). A convenient model that captures both of these deviations along with bona fide Brownian motion is fractional Brownian motion (FBM). Whereas pure Brownian motion is characterized by a single parameter (the diffusion coefficient) FBM is characterized by two: a scaling coefficient analogous to the diffusion coefficient and a Hurst parameter governing the type of motion. The Hurst parameter varies from 0 and 1, with 0.5 corresponding to Brownian motion and values above or below 0.5 corresponding to subdiffusion or superdiffusion respectively.

A GAT model was defined which is identical to the one used for compound effect prediction, but with a real-valued output rather than a distribution over categories (FIG. 6B). This model was trained on simulated SMT movies with fractional Brownian motions (FIG. 6A); these simulations incorporate a variety of realistic effects including defocus, motion blur, shot noise, and camera noise. The objective was to minimize the L2 loss between the predicted and true Hurst parameters for each spot in these simulated movies.

The trained model successfully distinguished between subdiffusion and superdiffusion, appearing to learn some notion of tracking relevant for making a similar prediction for different vertices in the same trajectory (FIG. 6C). The accuracy of the model was evaluated on a test set comprised of 340 movies, each of which contains particles with a different Hurst parameter and a variety of scaling coefficients (FIG. 6D). Because each particle has a mixture of scaling coefficients, there is no relation between the simulated Hurst parameter and the measured diffusion coefficient from our traditional tracking pipeline (FIG. 6D, left). However, the GNN successfully distinguished different classes of motion, although a slight bias toward Hurst=0.5 (FIG. 6D, right) was noted. This likely reflects that 0.5 is the mean Hurst value over the entire training dataset, and thus is the safest prediction a model can make with in the absence of sufficient information to predict the Hurst parameter.

Finally, the model's accuracy was evaluated at the single particle level (FIG. 6E), including on movies with a mixture of simulated Hurst parameters. For all Hurst parameters, the majority of predictions were typically within 0.1 of the true Hurst parameter. The same bias toward the middle Hurst parameter (0.5) that had previously seen at the movie level has been noted.

GATs as provided herein can be used for vertex regression tasks. GATS are particularly technically advantageous in that the approach does not require explicit tracking; instead, the notion of tracking is learned naturally by the network as needed.

The high-dimensional nature of video data poses a challenge for assays that require low-dimensional, interpretable readouts. This problem is especially pronounced with SMT, where the same data can be used to derive many different flavors of spatial and dynamical readouts. Identifying the readout appropriate for any given biological target and task can be a bottleneck of assay development.

The current subject matter is advantageous in that it uses weakly supervised GNNs to learn optimal readouts from SMT data in lieu of spot- or trajectory-level training data. Such models were shown to be capable of performing a variety of tasks useful for SMT assay development, including dye/junk monitoring, measuring compound effects, and anomalous diffusion measurements. Moreover, readouts from the GNNs were shown to be competitive with tracking-derived readouts on two exemplified targets (ER and Target 2), while requiring a small fraction of human effort.

A key insight is that although all of these models were trained with weak supervision—in effect assuming all particles from each training movie are identical—at inference time the models identified mixtures of different classes of particles in the same movie. In the case of ER, the relative class ratios match remarkably well with tracking-derived outputs (FIG. 4C). In the case of both ER and Target 2, changes in class ratios were as performant for an assay readout as changes in the ensemble dynamical characteristics (FIG. 4D, 5C). This confirms that weakly supervised training is a viable approach to contend with the paucity of labeled SMT training data at the single molecule level.

Several avenues to extend and generalize this framework are desirable from an assay development standpoint. Unlike ER and Target 2, not all protein targets have known tool compounds. Indeed, protein targets without tool compounds may be the most desirable targets for drug discovery efforts.

### Model Architecture

### Definitions of Layers Used in GNNs for SMT.

Example mathematical definitions for each of the layers used in an example GNN. Each layer is adapted to the unique character of SMT data, and in particular the central roles of space and time.

Unless otherwise noted, LeakyReLU was used for all activation functions. This choice is motivated by three considerations:
1. LeakyReLU satisfies the nonpolynomial property required for the MLP universal approximation theorem.
2. Unlike ReLU (or PReLU, generally), LeakyReLU is invertible and its derivative can be taken solely based on its output value, reducing the memory required for backpropagation without rematerialization.
3. The negative slope of LeakyReLU can be chosen to be a power of 2, coinciding with bitshift operations that are fast to implement in hardware.

### Geometric Prediffusion (GeoPrediff) Layers.

In the SIGN approach, one or more “prediffusion” layers are provided that mix input information between nearby vertices in the spot-link graph. In the example implementation, the information shared between vertices decays geometrically with the distance (minimum walk length) between the vertices. This version of prediffusion can be characterized as “geometric prediffusion” (GeoPrediff). Further, two flavors are defined—GeoPrediffV and GeoPrediffE—depending on whether a vertex- or edge-level attribute is targeted.

Because GeoPrediff layers have no trainable parameters, they are not subject to backpropagation, instead acting to enrich the input features associated with each vertex or edge.

Let X∈ [symbol] ^{N×n} be the input features associated with each of N vertices, so that xᵢ∈ [symbol] ⁿ is the vector of input features associated with vertex i. Then
Z=GeoPrediffV (X)∈ [symbol] ^{N×3n} is defined recursively in the following way:
   Z=GeoPrediffV (X)∈ [symbol] ^{N×3n} recursively in the following way:

$${α}_{j}^{( f )} = 1 + γ {\sum }_{i ∈ Pa ( j )} \frac{{β}^{{t}_{j} - {t}_{i}} {α}_{i}^{( f )}}{\sqrt{{d}_{i}^{( out )} {d}_{j}^{( in )}}}$$

$${α}_{i}^{( r )} = 1 + γ {\sum }_{i ∈ Ch ( i )} \frac{{β}^{{t}_{j} - {t}_{i}} {α}_{j}^{( r )}}{\sqrt{{d}_{i}^{( out )} {d}_{j}^{( in )}}}$$

$${y}_{j}^{( f )} = {x}_{j}^{( 0 )} + γ {\sum }_{i ∈ Pa ( j )} \frac{{β}^{{t}_{j} - {t}_{i}} {y}_{i}^{( f )}}{\sqrt{{d}_{i}^{( out )} {d}_{j}^{( in )}}}$$

$${y}_{i}^{( r )} = {x}_{i}^{( 0 )} + γ {\sum }_{i ∈ Ch ( i )} \frac{{β}^{{t}_{j} - {t}_{i}} {y}_{j}^{( r )}}{\sqrt{{d}_{i}^{( out )} {d}_{j}^{( in )}}}$$

$${z}_{i}^{( f )} = \frac{{y}_{i}^{( f )}}{{α}_{i}^{( f )}}$$

$${z}_{i}^{( r )} = \frac{{y}_{i}^{( r )}}{{α}_{i}^{( r )}}$$

$${z}_{i} = Concat ( {z}_{i}^{( f )} , {z}_{i}^{( r )} , {x}_{i} ) ( output for vertex i )$$

Here, γ, β∈[0, 1] are hyperparameters.

Similarly, if ΔX∈ [symbol] ^{E×n} is the set of input features associated with each of E edges so that Δzᵢⱼ is the vector of input features for edge i→j,
ΔZ-GeoPrediffE (X)∈ [symbol] ^{E×3n} is defined via

$${α}_{j}^{( f )} = γ {\sum }_{i ∈ Pa ( j )} \frac{{β}^{{t}_{j} - {t}_{i}} ( 1 + {α}_{i}^{( f )} )}{\sqrt{{d}_{i}^{( out )} {d}_{j}^{( in )}}}$$

$${α}_{i}^{( r )} = γ {\sum }_{i ∈ Ch ( i )} \frac{{β}^{{t}_{j} - {t}_{i}} ( 1 + {α}_{j}^{( r )} )}{\sqrt{{d}_{i}^{( out )} {d}_{j}^{( in )}}}$$

$${f}_{j}^{( f )} = γ {\sum }_{i ∈ Pa ( j )} \frac{{β}^{{t}_{j} - {t}_{i}} ( Δ {x}_{ij} + {f}_{i}^{( f )} )}{\sqrt{{d}_{i}^{( out )} {d}_{j}^{( in )}}}$$

$${f}_{i}^{( r )} = γ {\sum }_{i ∈ Ch ( i )} \frac{{β}^{{t}_{j} - {t}_{i}} ( Δ {x}_{ij} + {f}_{j}^{( r )} )}{\sqrt{{d}_{i}^{( out )} {d}_{j}^{( in )}}}$$

$$Δ {z}_{i}^{( f )} = {f}_{i}^{( f )} / ( {α}_{i}^{( f )} + \text{?} )$$

$$Δ {z}_{i}^{( r )} = {f}_{i}^{( r )} / ( {α}_{i}^{( r )} + \text{?} )$$

$$Δ {z}_{ij} = Concat ( Δ {x}_{ij} , Δ {z}_{ij}^{( f )} , Δ {z}_{ij}^{( r )} )$$

$$\text{?} \text{indicates text missing or illegible when filed}$$

As before, γ, β∈[0, 1] are hyperparameters and ε>0 is a small stability hyperparameter, usually chosen to be 10⁻⁶.

### Graph Convolution Layers (GCNs).

The definition of a simple graph convolution layer closely follows Kipf & Welling. One modification is to enable the layer to operate directly on edge-level attributes.

Suppose G=(V, E) is an input spot-link graph where each vertex i∈V is associated with a vector of attributes xᵢ∈ [symbol] ⁿ and each edge i→j∈E is associated with a vector of attributes yᵢⱼ∈ [symbol] ^{m}. The output of the layer is a vector zZᵢ∈ [symbol] ₚ associated with each vertex.

Then the GCN layer is defined as

$${z}_{i} = σ ( {a}_{i} )$$

$${a}_{j} = W \text{?} {x}_{j} + {\sum }_{i ∈ Pa ( j )} {ℓ}_{ij} ( {W}_{2} {x}_{i} + {W}_{3} {y}_{ij} ) + b$$

$$\text{?} \text{indicates text missing or illegible when filed}$$

where σ(⋅) is elementwise LeakyReLu, W₁, W₂∈ [symbol] ^{p×n}, W₃∈ [symbol] ^{p×m}, b∈ [symbol] ^{p}, and

$${ℓ}_{ij} = \frac{1}{\sqrt{{d}_{i}^{( out )} {d}_{j}^{( in )}}} where {d}_{i}^{( out )}$$

is the outdegree of vertex i and

$${d}_{j}^{( in )}$$

is the indegree of vertex j. lᵢⱼ is a coefficient related to the graph's normalized Laplacian.

This GCN layer can be equivalently defined with the convolution running in the reverse time direction. In practice, a chain of both forward-time and reverse-time GCNs can be used whose outputs are concatenated and projected to yield the output.

### Graph Attention Network (GAT) Layers.

The general idea of a GAT layer is to perform a graph convolution weighted by a set of normalized “attention coefficients” α. Here, a GAT is defined that takes advantage of the unique topological character of SMT—in particular the central role of time.

The layer accepts a graph G=(V, E) where each vertex is associated with vector xᵢ and each edge is associated with a vector yᵢⱼ. The output is one vector zᵢ for each vertex i.

$${a}_{ij} = {w}_{4}^{T} σ ( {W}_{1} {x}_{i} + {W}_{2} {x}_{j} + {W}_{3} {y}_{ij} )$$

$${a}_{ij}^{( f )} = \frac{{e}^{{a}_{ij}}}{{\sum }_{k ∈ Pa ( j )} {e}^{{a}_{kj}}}$$

$${a}_{ij}^{( r )} = \frac{{e}^{{a}_{ij}}}{{\sum }_{k ∈ Ch ( i )} {e}^{{a}_{ik}}}$$

$${z}_{j}^{( f )} = {x}_{j} + {\sum }_{i ∈ Pa ( j )} {a}_{ij}^{( f )} [ σ ( {W}_{5} {x}_{i} + {W}_{6} {y}_{ij} + {b}_{1} ) - {x}_{j} ]$$

$${z}_{i}^{( r )} = {x}_{i} + {\sum }_{j ∈ Ch ( i )} {a}_{ij}^{( r )} [ σ ( {W}_{7} {x}_{j} + {W}_{8} {y}_{ij} + {b}_{2} ) - {x}_{i} ]$$

$${z}_{i}^{( fr )} = Concat ( {z}_{i}^{( f )} , {z}_{i}^{( r )} )$$

$${z}_{i} = σ ( {W}_{9} {z}_{i}^{( fr )} + {b}_{3} )$$

Here, σ is the LeakyReLU activation function. Typically several of these layers are used in parallel, each representing an “attention head”. The outputs of all heads are then concatenated and projected to yield a new representation of each vertex. A representative example is provided below.

### Representative GNN Architectures for SMT

Describes below are two representative architectures which have been shown to successfully define GNNs for SMT.

### SIGN/GCN Architecture.

This architecture, which forms the basis for the dye classifier (FIG. 3), has four distinct stages:
1. Construct a graph incorporating both connections between adjacent spots as well as “skip-layer” connections between spots distal in time.
2. The input features associated with each vertex are enriched by a geometric prediffusion layer.
3. The prediffused inputs are fed into two chains of GCN layers, running forward and backward in time.
4. The outputs of the GCN layers are concatenated and projected to a low-dimensional vertex representation, yielding the output.

Specifically, a set of vertices V is provided and an edge is made for every two vertices i, j that are closer than 1.25 μm and separated by 1, 2, 3, 7, or 13 frames in time (corresponding to 0.01, 0.02, 0.03, 0.07, or 0.13 seconds respectively). Only edges pointing forward in time are allowed; the direction of edges is reversed as necessary for individual layers. Each vertex is associated with two “shape coefficients” computed during the detection step and each edge is associated with the corresponding change in xyt position as well as the mean squared displacement (MSD) (Δx²+Δy²)/t. The forward propagation proceeds as:

$${X}^{( 0 )} ∈ {ℝ}^{N \times 2} \text{:} vertex inputs ; 2 shape coefficients per vertex$$

$$Y ∈ {ℝ}^{\vert ℰ \vert \times 4} \text{:} edge inputs ; Δ xyt and MSD for each edge$$

$${X}^{( 1 )} = GeoPrediffV ( {X}^{( 0 )} )$$

$${X}^{( 2 )} = {σ}_{1} ( {X}^{( 1 )} {W}^{T} + b )$$

$${X}^{( 3 , f )} = {GCN}_{fwd} ( {X}^{( 2 )} , Y )$$

$${X}^{( 4 , f )} = {GCN}_{fwd} ( {X}^{( 3 , f )} , Y )$$

$${X}^{( 5 , f )} = {GCN}_{fwd} ( {X}^{( 4 , f )} , Y )$$

$${X}^{( 3 , r )} = {GCN}_{rev} ( {X}^{( 2 )} , Y )$$

$${X}^{( 4 , r )} = {GCN}_{rev} ( {X}^{( 3 , r )} , Y )$$

$${X}^{( 5 , r )} = {GCN}_{rev} ( {X}^{( 4 , r )} , Y )$$

$${X}^{( 6 )} = Concat ( {X}^{( 2 )} , {X}^{( 5 , f )} , {X}^{( 5 , r )} )$$

$${X}^{( 7 )} = {σ}_{2} ( {X}^{( 6 )} {W}^{T} + b )$$

$${X}^{( 8 )} = {σ}_{2} ( {X}^{( 7 )} {W}^{T} + b )$$

$$z = {σ}_{3} ( {X}^{( 8 )} w + b )$$

where σ₁ is LeakyReLU, σ₂ is PreLU, and σ₃ is the sigmoid activation function. GCN is the graph convolution network described in section A.2. W and b are used generically to refer to weights and biases where they appear (unique within each layer). The output z∈ [symbol] ^{N} is a scalar between 0 and 1 for each spot—for example, the probability that the spot is a dye molecule.

For training, a loss function is used that subsamples 10000 vertices per spot-link graph with replacement and computes the gradient with respect to a binary cross-entropy loss defined on the label of the parent movie. Specifically, suppose that G=(V, E) is a spot-link graph from a movie with label t∈{0, 1}. Let S be a sample of 10000 vertices from V (sampled with replacement). Then the loss for this graph is:

$$L = - \frac{1}{\vert 𝒮 \vert} {\sum }_{i ∈ 𝒮} [ t log {z}_{i} + ( 1 - t ) log ( 1 - {z}_{i} ) ]$$

where zᵢ is the output of the model above for vertex i∈S. Notice that this assumes that every vertex shares the label t; this is the weakly-supervised assumption. In the case of the dye classifier, a few hundred movies were sampled per minibatch. The loss over the minibatch is the sum of the loss over all movies in the minibatch.

### GAT Architecture.

The second architecture is based on the GATv2 framework of Brody, and bears a close resemblance to tracking algorithms. Here, the architecture used for the second target classifier (FIG. 5) is outlined, which predicts a distribution over 3 labels for each vertex.

With a sequence of vertices V from an SMT movie, an edge is constructed for every two vertices closer than 1.25 μm and 1, 2, 3, 5, or 7 frames apart in time. Only edges in the forward time direction are included; these are reversed for individual layers as shown below. Each vertex is associated with two “shape coefficients” computed during the detection step and each edge is associated with the corresponding change in xyt position as well as the mean squared displacement (MSD) (Δx²+Δy²)/t.

The forward propagation routine is defined as

$${X}^{( 0 )} ∈ {ℝ}^{N \times 2} \text{:} vertex inputs$$

$$Y ∈ {ℝ}^{\vert ℰ \vert \times 4} \text{:} edge inputs$$

$${X}^{( 1 )} = Concat ( GeoPrediffV ( {X}^{( 0 )} ) , GeoPrediffE ( Y ) )$$

$${X}^{( 2 )} = {σ}_{1} ( {X}^{( 1 )} {W}^{T} + b )$$

$${X}^{( 3 ,} {\text{?}}^{)} = GATv 5 ( {X}^{( 2 )} , Y )$$

$${X}^{( 3 ,} {\text{?}}^{)} = GATv 5 ( {X}^{( 2 )} , Y )$$

$${X}^{( 3 ,} {\text{?}}^{)} = GATv 5 ( {X}^{( 2 )} , Y )$$

$${X}^{( 3 )} = {σ}_{1} ( Concat ( {X}^{( 3 ,} {\text{?}}^{)} , {X}^{( 3 ,} {\text{?}}^{)} , {X}^{( 3 ,} {\text{?}}^{)} ) {W}^{T} + b )$$

$${X}^{( 4 ,} {\text{?}}^{)} = GATv 5 ( {X}^{( 3 )} , Y )$$

$${X}^{( 4 ,} {\text{?}}^{)} = GATv 5 ( {X}^{( 3 )} , Y )$$

$${X}^{( 4 ,} {\text{?}}^{)} = GATv 5 ( {X}^{( 3 )} , Y )$$

$${X}^{( 4 )} = {σ}_{1} ( Concat ( {X}^{( 4 ,} {\text{?}}^{)} , {X}^{( 4 ,} {\text{?}}^{)} , {X}^{( 4 ,} {\text{?}}^{)} ) {W}^{T} + b )$$

$${X}^{( 5 ,} {\text{?}}^{)} = GATv 5 ( {X}^{( 4 )} , Y )$$

$${X}^{( 5 ,} {\text{?}}^{)} = GATv 5 ( {X}^{( 4 )} , Y )$$

$${X}^{( 5 ,} {\text{?}}^{)} = GATv 5 ( {X}^{( 4 )} , Y )$$

$${X}^{( 5 )} = {σ}_{1} ( Concat ( {X}^{( 5 ,} {\text{?}}^{)} , {X}^{( 5 ,} {\text{?}}^{)} , {X}^{( 5 ,} {\text{?}}^{)} ) {W}^{T} + b )$$

$${X}^{( 6 )} = Concat ( {X}^{( 3 )} , {X}^{( 4 )} , {X}^{( 5 )} )$$

$${X}^{( 7 )} = σ \text{?} ( {X}^{( 6 )} {W}^{T} + b )$$

$${X}^{( 8 )} = {σ}_{2} ( {X}^{( 7 )} {W}^{T} + b )$$

$$Z ∈ {ℝ}^{\vert 𝒱 \vert \times 3} = Softmax ( {X}^{( 8 )} )$$

$$\text{?} \text{indicates text missing or illegible when filed}$$

Here, σ₁ is LeakyReLU and σ₂ is PReLU. W and b are used generically to refer to trainable weights and biases (unique within each layer). GeoPrediffV and GeoPrediffE are the geometric prediffusion layers described above and GATv5 is the graph attention network layer described above. In the last layer, the softmax function is defined over the three output attributes of each layer.

For training, a weakly-supervised, sample-based version of the cross-entropy loss was used. Suppose there is a movie with vertices V and truth label t∈{0, 1}^{K} (a one-hot vector), where K is the number of possible labels. Let S be a subsample of 10000 vertices from V (sampled with replacement). Then the loss can be defined as:

$$L = - \frac{1}{\vert 𝒮 \vert} {\sum }_{i ∈ 𝒮} \sum \text{?} {i}_{k} log {z}_{ik}$$

$$\text{?} \text{indicates text missing or illegible when filed}$$

### Gats and Probabilistic Tracking Algorithms

GATs were chosen as an architecture to quantify compound effects because of their close similarity to tracking algorithms and in particular probabilistic tracking algorithms. Here, this similarity is described by expanding a tracking formalism to include probabilistic tracking, then highlighting the relation with the attention mechanism in GATs.

As before, let V be the sequence of detections recovered from an SMT movie and X∈ [symbol] ^{|v|×n} be their attributes (such as spatiotemporal coordinates). There is a way to construct a graph G=(V, E) of possible ways to link detections into trajectories, and the goal of tracking is to identify some subset of edges S⊆E that minimize a loss:

$${𝒮}^{*} = {arg min}_{𝒮} f ( 𝒮 \vert 𝒱 , 𝒳 ) .$$

Probabilistic tracking generalizes this scheme. Rather than attempt to find a discrete subset S⊆E, instead each edge i→j∈E is assigned a probability lᵢⱼ∈[0, 1] such that sums over all outgoing or incoming link probabilities to each vertex are normalized:

$${\sum }_{j ∈ Ch ( i )} {ℓ}_{ij} \leq 1$$

$${\sum }_{i ∈ Pa ( j )} {ℓ}_{ij} \leq 1$$

$$1 - {\sum }_{j ∈ Ch ( i )} = Pr ( i ends its trajectory )$$

$$1 - {\sum }_{i ∈ Pa ( j )} = Pr ( j starts a trajectory )$$

The goal of tracking is then to identify the vector l given a particular graph G=(V, E) and attributes X. The discrete tracking algorithm described in the main text is a special case when all lᵢⱼ are 0 or 1.

In GATs, a set of attention coefficients α are computed over the incoming edges to each vertex. The vector of attention coefficients into each vertex j is always normalized via softmax

$$( {α}_{ij} = exp ( {a}_{ij} ) / {\sum }_{k ∈ Pa ( j )} exp ( {a}_{{k}_{j}} ) ) ,$$

so that the attention coefficients form a probability distribution. GATs then perform a graph convolution weighted by these attention coefficients.

The attention coefficients αᵢⱼ are similar to link probabilities lᵢⱼ in a probabilistic tracking algorithm. There are two differences: (1) the link probabilities are “doubly normalized” so that the sum of link probabilities into or out of each vertex is a distribution, and (2) the link probabilities allow for the possibility that a given vertex has no connection in the forward or reverse time directions.

The GAT attention mechanism as used herein is configured to more closely resemble a probabilistic tracking algorithm. First, two sets of attention coefficients are computed-one in the forward time and one in the reverse time direction (by reversing the directions of all edges). This leads to two graph convolutions per layer. Second, a special softmax is used to compute the attention coefficients that allows for the possibility that a vertex connects to nothing in the forward or reverse time directions. For instance, in the forward time direction, this is

$${α}_{ij} = \frac{exp ( {a}_{ij} )}{1 + {\sum }_{k ∈ Pa ( j )} exp ( {a}_{{k}_{j}} )}$$

The magnitudes of the pre-softmax coefficients αᵢⱼ effectively encode the probability that no connection is made.

### Computing Environment

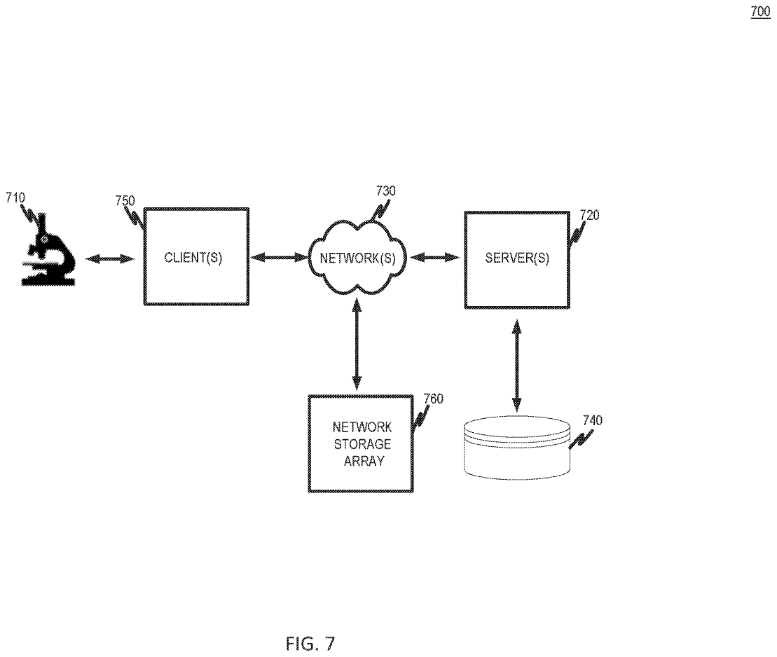

FIG. 7 illustrates an example computer-implemented environment 700 in which an imaging system 710 can interact with a computing architecture to perform the various algorithms described herein. As shown in FIG. 7, the imaging system 710 can interface with one or more clients 750. The one or more clients 750 can interface with one or more servers 720 accessible through the network(s) 730. The one or more clients 750 can host a frame grabber that captures images from a camera (e.g., movies). Those images can be temporarily stored on the one or more clients 750 and periodically transferred to the one or more servers 720 for remote storage via network 730. The one or more servers 720 can also contain or have access to one or more data stores 740 for storing data collected and/or extracted from a sample by imaging system 710. In some variations, the network 730 may include or interface with one or more network storage arrays 760 for storing data such as the captured images (e.g., movies).

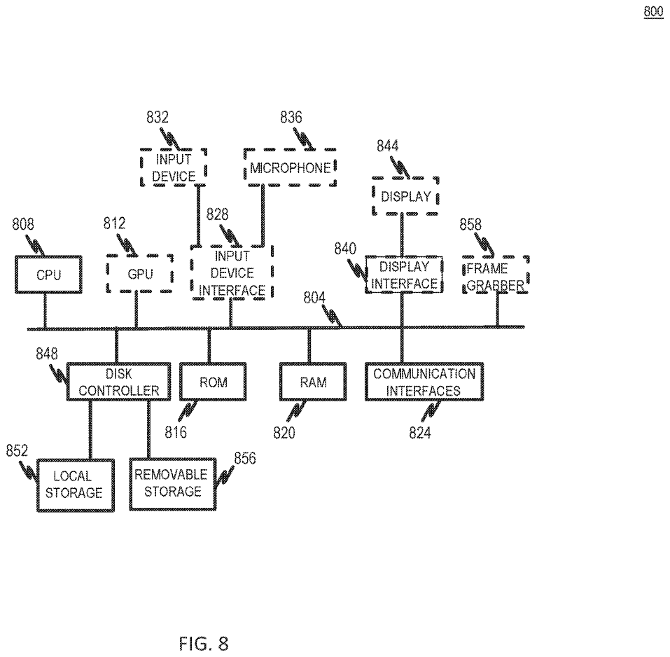

FIG. 8 is a diagram 800 illustrating a sample computing device architecture for implementing various aspects described herein. In some variations, the sample computing device architecture can be that of client(s) 750 and/or of server(s) 720 and some components described in relation to diagram 800 may be optional for the client(s) 750 and/or servers(s) 720. A bus 804 can serve as the information highway interconnecting the other illustrated components of the hardware. A processing system 808 labeled CPU (central processing unit) (e.g., one or more computer processors/data processors at a given computer or at multiple computers), can perform calculations and logic operations required to execute a program. Optionally or additionally, a processing system 812 labeled GPU (graphics processing unit) (e.g., one or more computer processors/data processors at a given computer or at multiple computers), can perform calculations and logic operations required to execute a program. A non-transitory processor-readable storage medium, such as read only memory (ROM) 816 and random access memory (RAM) 820, can be in communication with the processing system 808 and/or processing system 812 and can include one or more programming instructions for the operations specified here. Optionally, program instructions can be stored on a non-transitory computer-readable storage medium such as a magnetic disk, optical disk, recordable memory device, flash memory, solid state drive or other physical storage medium.

In one example, a disk controller 848 can interface with one or more optional removable storage 856 or local storage 852 to the system bus 804. The removable storage 856 can be external or internal disk drives, or solid state drives, or external hard drives. The local storage 852 can be internal hard drives and/or memory. As indicated previously, these various examples of removable storage 856, local storage 852, and disk controllers 848 are optional devices. The system bus 804 can also include at least one communications interface 824 to allow for communication with external devices either physically connected to the computing system or available externally through a wired or wireless network such as cloud storage and remote services. In some cases, the at least one communications interface 824 includes or otherwise comprises a network interface.

In some variations, such as for client(s) 750, to provide for interaction with a user, the subject matter described herein can be implemented on a computing device having a display device 844 (e.g., LCD (liquid crystal display) or LED (light-emitting diode) monitor, etc.) for displaying information obtained from the bus 804 via a display interface 840 to the user and an input device 832 such as keyboard and/or a pointing device (e.g., a mouse or a trackball) and/or a touchscreen by which the user can provide input to the computer. Other kinds of input devices 832 can be used to provide for interaction with a user as well; for example, feedback provided to the user can be any form of sensory feedback (e.g., visual feedback, auditory feedback by way of a microphone 836, or tactile feedback); and input from the user can be received in any form, including acoustic, speech, or tactile input. The input device 832 and the microphone 836 can be coupled to and convey information via the bus 804 by way of an input device interface 828. By way of example, input device 832 may be an imaging system 710 configured with abilities to capture a sequence of images as described herein. A frame grabber 858 can capture or grab individual frames from analog or digital data encapsulating the sequence of images obtained from the bus 804. Frame grabber 858 may include memory that can store individual or multiple frames. Frame grabber 858 can also provide individual or multiple frames to bus 804 for further storage on, for example, local storage 852 and/or removable storage 856. Other computing devices, such as dedicated servers, can omit one or more of the components described in connection with FIG. 8.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

### Molecular Analysis Tasks Using GNN

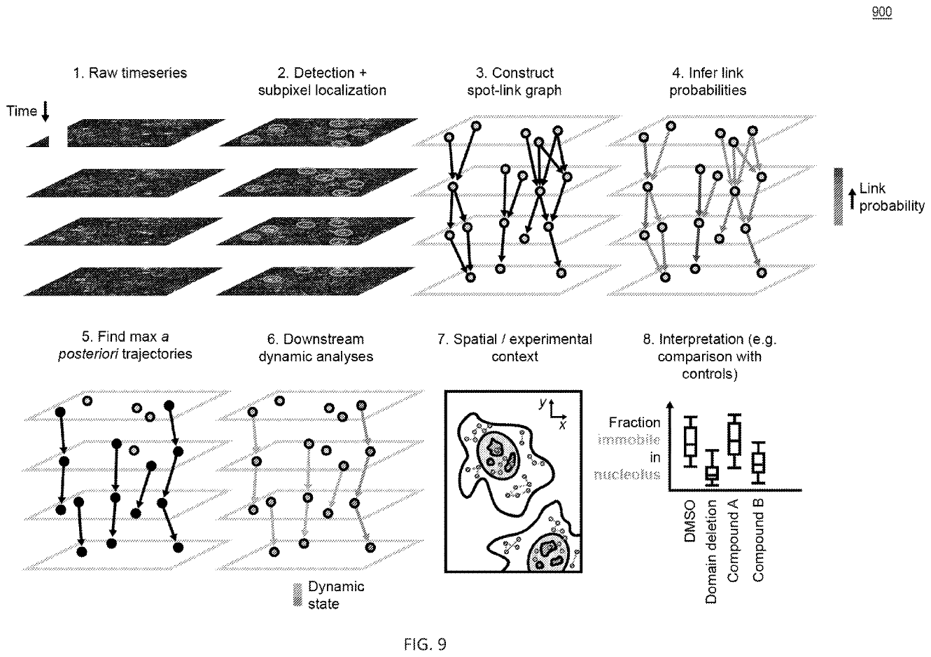

Various molecular analysis tasks can be performed as part of a larger workflow using graph neural networks for use by a consuming application or process (e.g., for providing insights 150 as described above, etc.). FIG. 9 is a diagram 900 illustrating a workflow in which the current subject matter can be integrated or otherwise utilized. Initially, at 900-1, a super resolution microscopy system can generate a sequence of images (e.g., movies, etc.) of a sample comprising a vast number of molecules and other components. Thereafter, at 900-2, various objects of interest (e.g., molecules, sub-cellular components, etc.) are detected within such images (see, for example, U.S. Pat. Apps. Ser. Nos. 63/476,941 and 63/476,942, the contents of both of which are hereby incorporated by reference) by identifying pixels/sub-pixels which are likely to be associated with a particular object (sometimes referred to as a spot) and associating a location of such object within the corresponding image. Using the detected spots, at 900-3, a spot-link graph can be generated which identifies potential trajectories (i.e., links) of the detected objects across the images. In some cases, there may be multiple possible trajectories for a single object so that, at 900-4, probabilities of the links are inferred using, for example, a graph neural network as further described below and/or using one or more probabilistic tracking techniques. The max a posteriori trajectories can then be determined, at 900-5, and data characterizing this determination can be provided, at 900-6, to downstream dynamic analyses or other processes. Visualizations providing spatial/experimental context can be provided, at 900-7, which can, in turn, be used at 900-8 as part of an analysis of the corresponding experiments (e.g., comparison relative to controls and the like). The linking operations (e.g., 900-4, etc.) can comprise a molecule analysis task so that downstream analyses and processes can, for example, focus on particular molecules, molecule trajectories, spots, and the like thereby making such downstream analyses and processes more efficient and/or more precise.

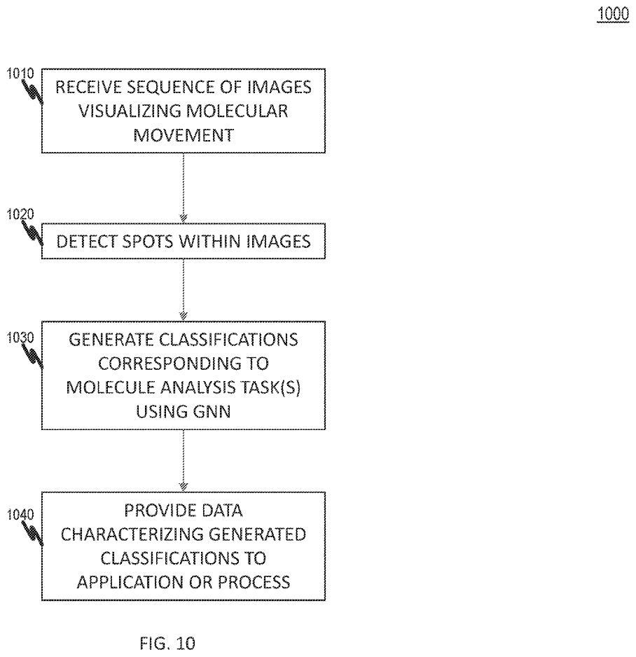

FIG. 10 is a process flow diagram 1000 in which, at 1010, a sequence of images visualizing movement of a plurality of molecules is received. Within these images, spots are detected, at 1020, which correspond to some or all of the molecules. Using these detected spots, a graph neural network such as a GAT is used, at 1030, to generate classifications corresponding to one or more molecule analysis tasks. Data characterizing these generated classifications are sent, at 1040, to a consuming application or process.

The graph neural network can take various forms including a graph attention network, a message passing network, a graph convolution network, a scalable injection graph neural network, and/or a network propagation model each comprising a plurality of layers.

The detecting can generate coordinates for each spot which are used to generate a vertex z representing one of the molecules. The graph attention network can compute, for each layer, attention coefficients α for each vertex z over neighbors corresponding to such vertex z and generates a new representation of such vertex z using graph convolutions weighted by the corresponding attention coefficients α. The attention coefficients α can vary over time.

The molecule analysis tasks can take varying forms. As one example, one of the molecule analysis tasks can be a graph classification. The graph classification can indicate whether the molecules in the sequence of images have been treated with one or more classes of compounds. As another example, one of the molecule analysis tasks can be a graph regression. In such an example, the graph neural network can output a single scalar number corresponding to an entire graph. This single scale number can predict a mean diffusion coefficient over all spots in the sequence of images and/or a concentration of a compound applied to the molecules. Another example of a molecule analysis task is a vertex classification. The vertex classification can specify a categorical attribute for each of the detected spots. The categorical attribute can specify whether the detected spots correspond to a molecule of interest, the detected spots as comprising dye or being junk and/or a type of motion for the molecule correspond to associated spot. One of the molecule analysis tasks can be an edge classification. The edge classification can specify or otherwise characterize a likely trajectory of a molecule within the sequence of images.

The sequence of images can comprise a sequence of microscopy images visualizing fluorescently-labeled cellular components in live cells. Further, the sequence of microscopy images can visualize the fluorescently-labeled cellular components while the live cells are being subjected to compounds or varying environmental conditions. In other variations, the sequence of microscopy images can visualize a cell-free sample.

In some variations, an ensemble of machine learning models can be utilized. In one variation, a sequence of images visualizing movement of a plurality of molecules is received (e.g., received after being transmitted over a computer network, accessed from storage, etc.). Spots within the images are detected which correspond to the plurality of molecules. The ensemble of machine learning models are used to analyze characteristics of the molecules within the sequence of images based on the detected spots. The ensemble of machine learning models can include a graph neural network and a probabilistic tracking algorithm. Data characterizing the analysis is provided to a consuming application or process. In some variations, as part of the analyzing, the probabilistic tracking algorithm can consume or otherwise utilize an output of the graph neural network.

In another variation, a sequence of images visualizing movement of a plurality of molecules is received (e.g., received after being transmitted over a computer network, accessed from storage, etc.). Spots within the images are detected which correspond to the plurality of molecules. Using a graph neural network and based on the detecting, molecules of interest are identified within the sequence of images. These identified molecules can then be analyzed (using for example, various computer vision or other machine learning algorithms, etc.) and data characterizing the analysis is provided to a consuming application or process. This consuming application or process can be yet another machine learning model or models which can characterize the molecules.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
receiving a sequence of images visualizing movement of a plurality of molecules;
detecting, within the images, spots corresponding to the plurality of molecules;
generating, using a graph neural network and based on the detecting, classifications corresponding to one or more molecule analysis tasks; and
providing data characterizing the generated classifications to a consuming application or process.

2. The method of claim 1, wherein the graph neural network comprises a graph attention network comprising a plurality of layers.

3. The method of claim 1, wherein the graph neural network comprises one or more of a: a graph attention network, a message passing network, a graph convolution network, a scalable injection graph neural network, or a network propagation model.

4. The method of claim 1, wherein the detecting generates coordinates for each spot which are used to generate a vertex z representing one of the molecules.

5. The method of claim 4, wherein, for each layer, the graph attention network computes attention coefficients α for each vertex z over neighbors corresponding to such vertex z and generates a new representation of such vertex z using graph convolutions weighted by the corresponding attention coefficients α.

6. The method of claim 5, wherein the attention coefficients α vary over time.

7. The method of claim 1, wherein one of the molecule analysis tasks comprises a graph classification.

8. The method of claim 7, wherein the graph classification indicates whether the molecules in the sequence of images have been treated with one or more classes of compounds.

9. The method of claim 1, wherein one of the molecule analysis tasks comprises a graph regression.

10. The method of claim 9, wherein the graph neural network outputs a single scalar number to an entire graph.

11. The method of claim 10, wherein the single scalar number predicts a mean diffusion coefficient over all spots in the sequence of images.

12. The method of claim 10, wherein the single scalar number predicts a concentration of a compound applied to the molecules.

13. The method of claim 1, wherein one of the molecule analysis tasks comprises a vertex classification.

14. The method of claim 13, wherein the vertex classification specifies a categorical attribute for each of the detected spots.

15. The method of claim 14, wherein the categorical attribute specifies whether the detected spots correspond to a molecule of interest.

16. The method of claim 15, wherein the categorical attribute specifies the detected spots as comprising dye or being junk.

17. The method of claim 14, wherein the categorical attribute characterizes a type of motion for the molecule correspond to associated spot.

18. The method of claim 1, wherein one of the molecule analysis tasks comprises an edge classification.

19. The method of claim 18, wherein the edge classification specifies a likely trajectory of a molecule within the sequence of images.

20. A method comprising:
receiving a sequence of images visualizing movement of a plurality of molecules;
detecting, within the images, spots corresponding to the plurality of molecules;
analyzing, using an ensemble of machine learnings and based on the detecting, characteristics of the molecules within the sequence of images, the ensemble of machine learning models comprising a graph neural network and a probabilistic tracking algorithm; and
providing data characterizing the analysis to a consuming application or process.

21. The method of claim 20, wherein, as part of the analyzing, the probabilistic tracking algorithm utilizes an output of the graph neural network.

22. A method comprising:
receiving a sequence of images visualizing movement of a plurality of molecules;
detecting, within the images, spots corresponding to the plurality of molecules;
identifying, using a graph neural network and based on the detecting, molecules of interest within the sequence of images;
analyzing the identified molecules of interest; and
providing data characterizing the analysis to a consuming application or process.

23. The method of claim 22 further comprising:
inputting the provided data into one or more machine learning models to characterize the molecules.

24. The method of claim 22, wherein the sequence of images comprise a sequence of microscopy images visualizing fluorescently-labeled cellular components in live cells.

25. The method of claim 24, wherein the sequence of microscopy images visualize the fluorescently-labeled cellular components while the live cells are being subjected to compounds or varying environmental conditions.

26. The method of any of claim 22, wherein the sequence of microscopy images visualize a cell-free sample.

27. A system comprising:
at least one data processor; and
memory storing instructions, which when executed by at least one data processor, result in operations for implementing operations comprising:
receiving a sequence of images visualizing movement of a plurality of molecules;
detecting, within the images, spots corresponding to the plurality of molecules;
generating, using a graph neural network and based on the detecting, classifications corresponding to one or more molecule analysis tasks; and
providing data characterizing the generated classifications to a consuming application or process.

28. A non-transitory computer program product storing instructions, which when executed by at least one data processor forming part of at least one computing device, implement operations comprising:
receiving a sequence of images visualizing movement of a plurality of molecules;
detecting, within the images, spots corresponding to the plurality of molecules;
generating, using a graph neural network and based on the detecting, classifications corresponding to one or more molecule analysis tasks; and
providing data characterizing the generated classifications to a consuming application or process.
